(19) United States
(12) Patent Application Publication
(10) Pub. No.: US 2026/0313022 A1
(43) Pub. Date: Oct. 8, 2026

(54) DISTRIBUTED MEMORY WITH PRE-COMPUTED KEY AND VALUE (KV) ENTRIES FOR INFERENCE OPERATIONS

(71) Applicant: Mellanox Technologies, Ltd., Yokneam (IL)

(72) Inventors: Alireza Farshin, Hägersten (SE); Omri Kahalon, Sylvan Lake (CA); Liran Liss, Atzmon-Segev (IL); Aviad Shaul Yehezkel, Yokneam Illit (IL); Vishwanath Venkatesan, Austin, TX (US)

(21) Appl. No.: 19/173,029

(22) Filed: Apr. 8, 2025

(51) Int. Cl. H04L 67/1097; G06F 16/22; G06N 5/043

(52) U.S. Cl. CPC H04L 67/1097; G06F 16/2237; G06N 5/043

(57) ABSTRACT

Technologies for distributed memory with pre-computed key and value (KV) entries for inference operations are described. One programmable network device receives, from a first inference node a first request to fetch input context for a first inference task being executed by the inference node, and determines that a set of pre-computed KV entries for the input context are stored in the one or more remote nodes. The programmable network device fetches, from the one or more remote nodes over the network, the set of pre-computed KV entries for the input context, and loads the set of pre-computed KV entries into local memory of the inference node.

### RELATED APPLICATIONS

This application is related to co-pending U.S. Application No. [not yet assigned], entitled “Distributed Memory for Inference Operations,” and co-pending U.S. Application No. [not yet assigned], entitled “Distributed Memory with Subsets of Model Weights or Parameters based on Inference Task Types,” the entire contents of which are incorporated by reference.

### TECHNICAL FIELD

At least one embodiment pertains to processing resources used to manage hierarchical distributed memory for inference operations. For example, at least one embodiment pertains to a programmable network device that handles operations related to memory and coherency between an inference node and one or more remote nodes.

### BACKGROUND

Large Language Models (LLMs) are advanced artificial intelligence systems trained on massive datasets to understand and generate human-like text. They use deep learning techniques, particularly transformer architectures, to process and predict language patterns. LLMs can perform various natural language processing (NLP) tasks, such as text generation, translation, summarization, and question-answering. These models improve over time through training on diverse data, enabling them to produce contextually relevant and coherent responses. The rise of LLMs has resulted in many new applications and online services, and this trend is expected to stay, which would put higher demand on the model inferencing infrastructure.

### BRIEF DESCRIPTION OF DRAWINGS

Various embodiments in accordance with the present disclosure will be described with reference to the drawings, in which:

FIG. 1A is a block diagram of an inference system with a distributed memory hierarchy according to at least one embodiment.

FIG. 1B illustrates a distributed memory hierarchy of the inference system of FIG. 1A according to at least one embodiment.

FIG. 2 is a block diagram of a distributed hierarchical memory manager in an initialization phase according to at least one embodiment.

FIG. 3 is a block diagram of a distributed hierarchical memory manager in an operation phase according to at least one embodiment.

FIG. 4A is a block diagram of a programmable network device with a distributed hierarchical memory manager according to at least one embodiment.

FIG. 4B is a block diagram of the programmable network device with the distributed hierarchical memory manager for managing domain-specific sub-models for inference according to at least one embodiment.

FIG. 4C is a block diagram of the programmable network device with the distributed hierarchical memory manager for managing pre-computed KV entries for an inference task according to at least one embodiment.

FIG. 5 is a block diagram of an example system architecture of a data processing unit (DPU) with a distributed hierarchical memory manager, according to at least one embodiment.

FIG. 6 is a flow diagram of a method for managing a distributed memory hierarchy according to at least one embodiment.

FIG. 7 is a flow diagram of a method for managing a distributed memory hierarchy according to at least one embodiment.

FIG. 8 is a flow diagram of a method for managing a distributed memory hierarchy according to at least one embodiment.

FIG. 9 is a block diagram illustrating an exemplary computer system with a processor that may include execution units to execute an instruction, according to at least one embodiment.

FIG. 10 is a block diagram of a computing system having two processing devices coupled to each other and multiple networks according to at least one embodiment.

FIG. 11 is a block diagram of a computing system having a central processing unit (CPU) and a graphics processing unit (GPU) in a single integrated circuit according to at least one embodiment.

FIG. 12 is a block diagram of a computing system having tensor core graphics processing units (GPUs) according to at least one embodiment.

### DETAILED DESCRIPTION

Technologies for distributed memory for inference operations are described. The following description sets forth numerous specific details, such as examples of specific systems, components, methods, and so forth, in order to provide a good understanding of several embodiments of the present disclosure. It will be apparent to one skilled in the art, however, that at least some embodiments of the present disclosure may be practiced without these specific details. In other instances, well-known components or methods are not described in detail or presented in simple block diagram format to avoid obscuring the present disclosure unnecessarily. Thus, the specific details set forth are merely exemplary. Particular implementations may vary from these exemplary details and still be contemplated to be within the scope of the present disclosure.

As described above, the trend of LLMs puts a higher demand on the model inferencing infrastructure, such as memory footprint of LLMs. In particular, LLMs are continually growing in model size (i.e., the number of parameters) and in context size (i.e., the number of input tokens), e.g., recent models have hundreds of billions of parameters and support up to 1 million input tokens. The increase in the number of parameters in LLMs leads to higher model weights and larger context sizes, which in turn increases the memory requirements. Larger context sizes, which allow LLMs to receive more tokens, affect the local memory used for (i) model weights and (ii) working memory that is primarily used for caching key and value (KV) states (referred to as KV entries or KV cache), used during LLM inference to optimize response generation. As LLMs get bigger, they require more memory, which can exceed the capacity of a single graphics processing unit (GPU) or even a node with multiple GPUs.

Existing inference frameworks typically rely on the local memory of an inference node (single GPU, artificial intelligence (AI) accelerator, or multiple GPUs) to perform inference requests. In particular, existing inference systems require all model weights to be able to serve an inference request, which typically requires a large local memory on the GPU or AI accelerator to perform fast and efficient inference operations. For LLM inference, the local memory currently is used for (i) model weights and (ii) working memory that is primarily used for caching key and value states (aka KV cache) and is dependent on the context size. However, the model size and context size are constantly growing, which can easily increase the memory requirements of an inference operation beyond the memory capacity of a single inference node.

To overcome this limitation, some typically rely on compression techniques, including quantization or pruning, to reduce the memory requirement and accelerate inference operations, sacrificing the model accuracy. Existing pruning techniques usually use a single mask for zeroing out the model weights, where different request types rely on the same set of model weights to perform the inference operations. However, building a custom mask for different request types (e.g., a mask for each programming language, a mask for a language translation, and/or a mask for logical reasoning, and mathematical analysis) could significantly improve the accuracy of the pruned models.

Aspects and embodiments of the present disclosure address these problems and others by providing a distributed hierarchical memory manager, a type of distributed memory logic, to handle operations related to memory and coherency between an inference node and one or more remote nodes for inference operations. Aspects and embodiments of the present disclosure can employ one or more programmable network devices (e.g., smart network interface cards (NICs), network adapters, data processing units (DPUs), etc.) to manage a distributed memory hierarchy. The programmable network devices can be used to build a distributed memory hierarchy among different inference nodes and distributed remote memory/storage nodes, which can support different levels of caching and eviction policies. The distributed memory logic causes programmable devices to provide an interface to the inference node that enables the inference node to seamlessly fetch the relevant entries. By doing so, inference nodes can (i) store large amount of key and value states or model weights or parameters on remote memories, (ii) only fetch the relevant entries into their local memory from the closest memory, and (iii) rely on the programmable network devices to handle the memory coherency among different nodes. Moreover, aspects and embodiments of the present disclosure make it possible to use one or multiple nodes (e.g., use sharding or replication) as the “main memory” and store the model weights and KV cache entries, which enables reusing the model weights or parameters and key-value states among different inference nodes.

Aspects and embodiments of the present disclosure can scale out the memory of a single inference node to distributed remote memory/storage and support task-aware/request-type-aware inference operations to be able to only fetch relevant model weights or parameters into the local memory of an inference node.

It should be noted that difference inference tasks activate different parts of a model. Aspects and embodiments of the present disclosure can use these results to create different task/request-aware pruning masks for each model and only load the relevant model weight to the local memory of an inference node according to the request types. For instance, an inference node receiving programming-related inference tasks can only fetch the model weights or parameters that is necessary for performing the inference on these tasks.

As opposed to the existing solutions, aspects and embodiments of the present disclosure can build a distributed hierarchical memory for an inference node and relies on programmable network devices to handle memory operations and memory coherency. Aspects and embodiments of the present disclosure can prefetch appropriate KV entries and model weights (or parameters) from remote memories into the local memory and GPU memory based on the scheduled inference workload. Aspects and embodiments of the present disclosure can evict unused model weights (or parameters) according to request types. Aspects and embodiments of the present disclosure can manage the local and remote memories according to the user preference.

Using a distributed memory for inference not only increases the capacity of local inference memory, but also enables request parallelization, as different requests can still reuse their previously calculated KV cache entries without re-computing them (i.e., evicting them to a remote memory instead of discarding them). Accelerating memory management using programmable network devices (e.g., DPU) makes it possible to perform zero-copy and directly load the relevant entries into the GPU memory without any additional Peripheral Component Interconnect Express (PCIe) overhead. Moreover, it makes it possible to remove a CPU from the memory nodes and create DPU-attached memory nodes.

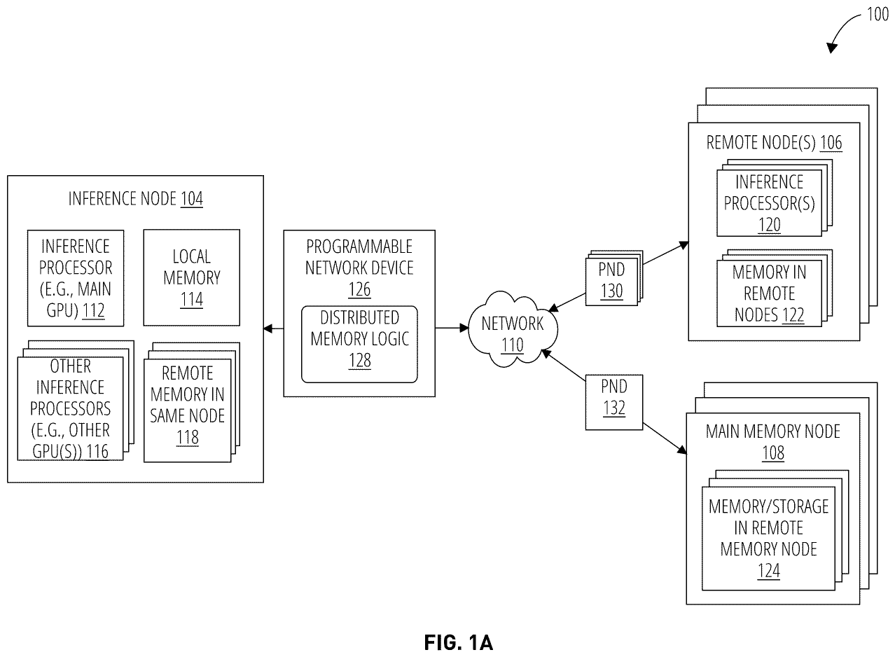

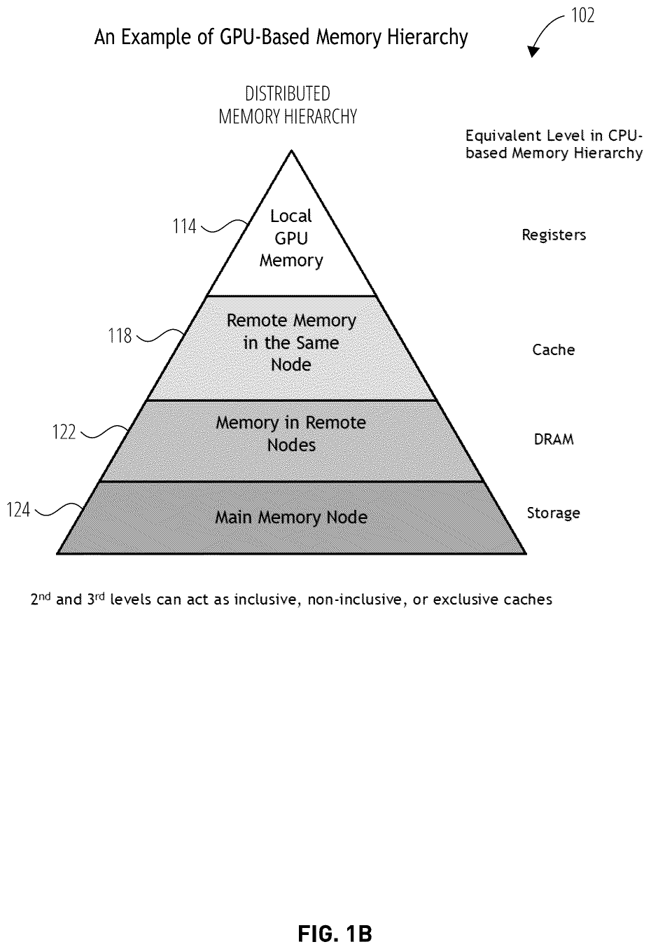

FIG. 1A is a block diagram of an inference system 100 with a distributed memory hierarchy according to at least one embodiment. The inference system 100 includes an inference node 104, one or more remote node(s) 106, and a main memory node 108. The inference node 104, remote node(s) 106, and main memory node 108 can be communicatively coupled over a network 110. As illustrated in FIG. 1A, the inference node 104 is communicatively coupled to the network 110 using a programmable network device 126. The inference node 104 includes an inference processor 112 (e.g., a main GPU or accelerator, etc.), local memory 114 (e.g., local GPU memory), and zero or more other inference processors 116 and corresponding memory (e.g., GPU memory) of the other inference processors 116 (e.g., other GPU(s)), referred to as remote memory in same node 118 since the reside in the inference node 104. Similarly, the remote node(s) 106 and the main memory node 108 can be operatively coupled to the network 110 using one or more programmable network device(s) 130 and a programmable network device 132, respectively. A programmable network device is a hardware component, such as a NIC, a smart NIC, a DPU, a network adapter, a network switch, or a network interconnect device, in a network that can be configured or controlled through software to perform specific network functions or behaviors. The programmable network device can support software-defined customization of its data plane or control plane behavior. These devices allow developers or administrators to dynamically modify how network traffic is processed, routed, filtered, or accelerated, often through programmable pipelines, application programming interfaces (APIs), or domain-specific languages. The remote node(s) 106 can include one or more inference processor(s) 120 with corresponding memory (e.g., GPU memory), referred to as memory in remote nodes 122. The main memory node 108 can be a dedicated node including memory/storage in remote memory node 124. In at least one embodiment, the main memory node 108 can also include multiple nodes, where the multiple nodes can be replicated nodes. In other embodiments, the main memory can be partitioned among multiple main memory nodes 108.

In at least one embodiment, the programmable network device 126 can be a NIC, a smart NIC, a DPU, a network adapter, a network switch, a network interconnect device, or the like. The programmable network device 126 includes distributed memory logic 128 to configure and manage a distributed memory hierarchy for the inference node 104. An example distributed memory hierarchy 102 is illustrated and described below with respect to FIG. 1B. Similarly, the programmable network device(s) 130 and programmable network device 132 can be NICs, smart NICs, DPUs, network adapters, network switches, network interconnect devices, or the like. It should be noted that the distributed memory logic 128, programmable network device(s) 130, and programmable network device 132 can be the same or different types of programmable network devices.

In at least one embodiment, the programmable network device 126 implements the distributed memory logic 128 as hardware, such as combinational logic, hardware state machine, or the like. In at least one embodiment, the programmable network device 126 implements the distributed memory logic 128 as software, referred to herein as distributed hierarchical memory manager. In other embodiments, the distributed memory logic 128 can be implemented as hardware, firmware, software, or any combination thereof. In at least one embodiment, the programmable network device 126 includes one or more hardware acceleration hardware engines to handle operations related to memory and coherency between the inference node 104 and the one or more remote node(s) 106 or the main memory node 108. In at least one embodiment, the programmable network device 126 is a DPU, including DPU hardware and DPU software. The distributed memory logic 128 can manage distributed memory for inference operations by the inference node 104. In particular, the distributed memory logic 128 can receive information about a set of memory nodes, including the local memory 114, the remote memory in same node 118, the memory in remote nodes 122, and the memory/storage in remote memory node 124 in the inference system 100. The distributed memory logic 128 can create a distributed memory hierarchy 102 for a class of inference request. Each memory node can be used as an inclusive, non-inclusive, or exclusive cache. The distributed memory logic 128 can manage mapping, loading, writebacks, and coherency operations for (i) model weights or parameters and (ii) active memory (e.g., context/attention KV states). Managing the model weights or parameters is important for domain-specific models where a subset of weight can be used for a certain task (i.e., typically each model has a common set of weights and domain-specific weights that are only relevant for specific tasks). Managing the active memory (e.g., KV entries) is important when there is a large context and recalculating KV entries (e.g., when passing the whole PDF or reusing the chat history) is undesirable. Also, managing the active memory (e.g., KV entries) is important when providing a more accurate context to the model (e.g., RAG) is desired due to a limited context size and faster inference time. The pre-calculated KV entries, provided by a vector database/RAG, can be used to improve the response quality. In at least one embodiment, the distributed memory logic 128 can receive a set of configurations and builds a model-specific distributed memory hierarchy for each class of inference. In at least one embodiment, the distributed memory logic 128 can receive a set of configurations and builds a general distributed memory hierarchy for inference operations without the specificity of a specific class of inference.

In at least one embodiment, the programmable network device 126 includes a processing unit, memory operatively coupled to the processing unit, and a network interface operatively coupled to the processing unit, the inference node 104, the remote node(s) 106, and the main memory node 108. The programmable network device 126 can be coupled to the inference node 104 over a PCIe interconnect over the network 110. It should be noted that, in other embodiments, the programmable network device 126 can be integrated into the inference node (e.g., an inference accelerator). or a GPU). In another embodiment, the programmable network device 126 is coupled to the inference node 104 over the network 110. The programmable network device 126 is coupled to the remote node(s) 106 and main memory node 108 over the network 110. The memory of the programmable network device 126 can store instructions that, when executed by the processing unit, cause the programmable network device 126 to operate as a distributed hierarchical memory manager to handle operations related to memory and coherency between the inference node 104, the remote node(s) 106, and the main memory node 108.

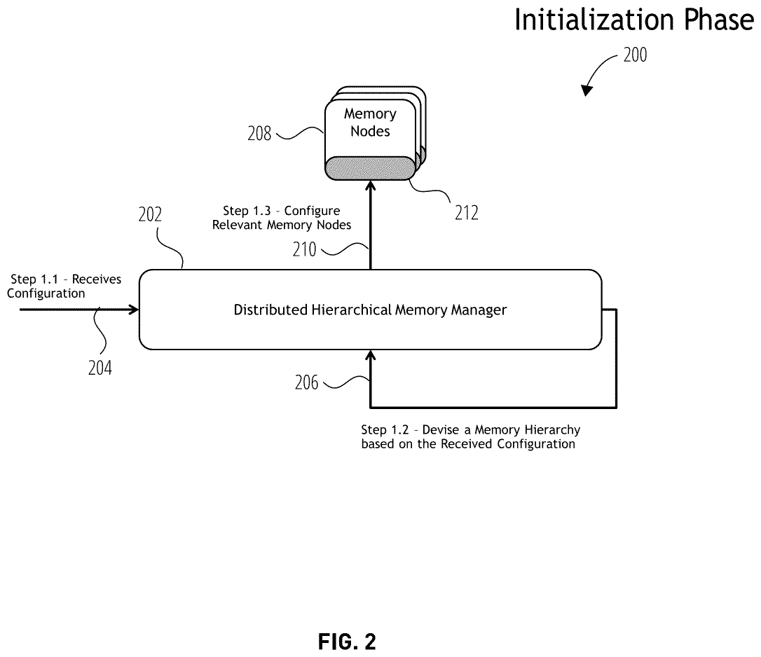

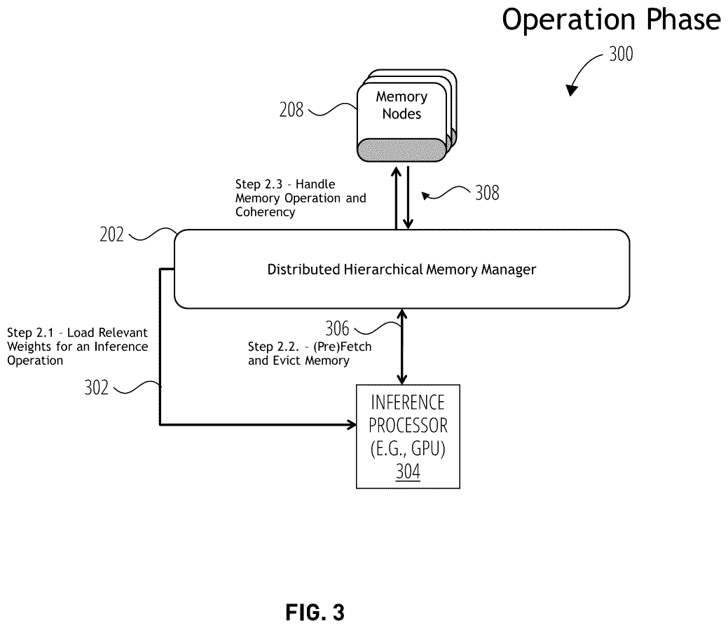

Additional details of the distributed memory logic 128 are described below with respect to the distributed hierarchical memory manager of FIG. 2 and FIG. 3.

FIG. 1B illustrates a distributed memory hierarchy 102 of the inference system 100 of FIG. 1A according to at least one embodiment. The distributed memory hierarchy 102 organizes the memory nodes into multiple memory levels. As illustrated in FIG. 1B, the distributed memory hierarchy 102 includes the local memory 114 as a first-level memory, the remote memory in same node 118 as a second-level memory, the memory in remote nodes 122 as a third-level memory, and a memory/storage in remote memory node 124 as a fourth-level memory. It should be noted that the distributed memory hierarchy 102 is an example of GPU-based distributed memory hierarchy, referencing local GPU memory as the first-level memory. However, in other embodiments where an inference processor is used, the first-level memory can be local memory to the inference processor.

As a comparison, the distributed memory hierarchy 102 can be compared against the multiple levels in a CPU-based memory hierarchy. The CPU-based memory hierarchy includes registers as a first-level memory, cache as a second-level memory, dynamic random access memory (DRAM) as a third-level memory, and storage as a fourth-level memory. In other embodiments, the levels of the distributed memory hierarchy 102 can include more or less levels. In at least one embodiment, the second-level and third-level memory can act as inclusive, non-inclusive, or exclusive caches for the inference node 104. In other embodiments, the memory/storage in remote memory node 124 can be further separated into different levels, such as one level for memory and one level for storage. The level used for memory can also act as an inclusive, non-inclusive, or exclusive cache for the inference node 104. In at least one embodiment, the memory/storage in remote memory node 124 can store all model weights and parameters of an inference model. The model weights for a particular inference request can be cached closer to the inference node 104, such as at the first-level memory (e.g., local memory 114) or second-level memory (e.g., remote memory in same node 118).

In at least one embodiment, the inference system 100 for performing inference operations includes the inference node 104, including the inference processor 112 with local memory 114, additional memory, and zero or more inference processor(s) 120, one or more remote node(s) 106 with remote memory (e.g., memory in remote nodes 122), and the programmable network device 126. The programmable network device 126 is coupled to the inference node 104 and the remote node(s) 106. The programmable network device 126 can receive configuration data identifying a set of memory nodes, each memory node located at the inference node 104 or the remote node(s) 106. The set of memory nodes includes the local memory, the additional memory, and the remote memory. The programmable network device 126 can determine, using the configuration data, a distributed memory hierarchy that organizes the set of memory nodes into a set of memory levels for the inference processor 112. The programmable network device 126 can configure each of the set of memory nodes according to the distributed memory hierarchy. The programmable network device 126 can receive one or more requests from the inference processor 112 over a host interface, and interact with one or more of the set of memory nodes over a network interface to perform memory operations for the inference processor 112. In at least one embodiment, the programmable network device 126 can receive one or more requests from the inference processor 112 over a first interface, and interact with one or more of the set of memory nodes over a second interface to perform memory operations for the inference processor 112. As described herein, the programmable network device 126 can be a CPU, a GPU, a DPU, a network adapter, a network switch, or an NVLink switch.

FIG. 2 is a block diagram of a distributed hierarchical memory manager 202 in an initialization phase 200 according to at least one embodiment. In at least one embodiment, the distributed hierarchical memory manager 202 is the distributed memory logic 128 of FIG. 1A. The distributed hierarchical memory manager 202 can be hardware, software, firmware, or any combination thereof, as described herein. In at least one embodiment, the distributed hierarchical memory manager 202 is implemented in a programmable network device with hardware acceleration capabilities, serving as the gateway between the inference processor 112 and a set of memory nodes 208. Each of the set of memory nodes 208 can operate with a programmable network device 212. Each of the programmable network devices 212 can communicate with the distributed hierarchical memory manager 202. The programmable network devices 212 can be similar to the programmable network devices 130, 132 of FIG. 1A.

In the initialization phase 200, the distributed hierarchical memory manager 202 can receive configuration data 204. The configuration data 204 can identify a set of memory nodes 208. Each of the set of memory nodes 208 is located at the inference node 104 or at the remote node(s) 106 or main memory node 108. In at least one embodiment, a user (e.g., a system administrator) can provide the configuration data 204 needed for managing a distributed hierarchical memory. In at least one embodiment, the configuration data 204 includes any one or more of the following: identification information for the plurality of memory nodes; allocation information for each of the plurality of memory nodes; role information for each of the plurality of memory nodes; eviction policy information for each of the plurality of memory nodes; control-level protocol information for each of the plurality of memory nodes; supported operations information for the plurality of memory nodes; model mask information for each request type; and expected workload information. In at least one embodiment, the configuration data 204 can include different eviction policies for different levels of the distributed memory hierarchy. In at least one embodiment, the configuration data 204 includes a first eviction policy for first-level memory of the set of memory levels of the distributed memory hierarchy, and a second eviction policy for second-level memory of the set of memory levels of the distributed memory hierarchy, where the first eviction policy and the second eviction policy are different.

In at least one embodiment, the distributed hierarchical memory manager 202 can determine, using the configuration data 204, a distributed memory hierarchy (e.g., distributed memory hierarchy 102) that organizes the set of memory nodes 208 into multiple memory levels for the inference node 104. The distributed hierarchical memory manager 202 can perform one or more configure operations 210 to configure each of the set of memory nodes 208 according to the distributed memory hierarchy.

In at least one embodiment, as part of configuring each of the set of memory nodes 208 according to the distributed memory hierarchy, the distributed hierarchical memory manager 202 can configure other programmable network devices (e.g., programmable network device(s) 130, programmable network device 132) attached to each of the one memory nodes (e.g., remote node(s) 106, main memory node 108). In at least one embodiment, the distributed hierarchical memory manager 202 can configure, according to a set of rules to manage memory spread across the set of memory nodes 208 according to the distributed memory hierarchy, a second programmable network device. The distributed hierarchical memory manager 202 can register memory regions in the memory nodes 208 for zero-copying transfers between memories. In at least one embodiment, the configure operation 210 can include registering memory regions for model weights or parameters and their respective KV entries for zero-copying transfers into local memory 114 (e.g., GPU memory) in the inference processor 112 (e.g., main GPU) of the inference node 104. In at least one embodiment, the distributed hierarchical memory manager 202 can set up the memory nodes 208 and define their roles as the first-level memory, the second-level memory, the third-level memory, the fourth-level memory. These roles can be defined by a network administrator in the configuration data 204.

After completion of the initialization phase 200, the distributed hierarchical memory manager 202 can operate in an operation phase in which the distributed hierarchical memory manager 202 can receive one or more requests from the inference node over the host interface, and interact with one or more of the set of memory nodes 208 over the network interface to perform memory operations for the inference node 104. In the operation phase, the distributed hierarchical memory manager 202 can check whether the required model weights or KV entries exist on the inference processor (or inference node). If not, the distributed hierarchical memory manager 202 can fetch or prefetch them from the memory nodes 208 in the distributed memory hierarchy. The distributed hierarchical memory manager 202 can operates as a gateway between the inference processor 112 (or inference node 104), and other memory nodes in the distributed memory hierarchy over the network 110. Additional details of the operation phase are described below with respect to FIG. 3.

FIG. 3 is a block diagram of a distributed hierarchical memory manager 202 in an operation phase 300 according to at least one embodiment. In at least one embodiment, the distributed hierarchical memory manager 202 is the distributed memory logic 128 of FIG. 1A. The distributed hierarchical memory manager 202 can be hardware, software, firmware, or any combination thereof, as described herein. In at least one embodiment, the distributed hierarchical memory manager 202 is implemented in a programmable network device with hardware acceleration capabilities, serving as the gateway between the inference processor 112 and the set of memory nodes 208.

In the operation phase 300, the distributed hierarchical memory manager 202 can perform a load operation 302 to an load a set of model weights or parameters into a first-level memory of the of the distributed memory hierarchy, the first-level memory being the closer to an inference processor 304 (e.g., GPU) of an inference node than other memory levels in the distributed memory hierarchy. The inference processor 304 can be the inference processor 112 of FIG. 1A. The distributed hierarchical memory manager 202 can load the model weights or parameters for an inference task (or inference operation) executed or to be executed by the inference processor 304. The distributed hierarchical memory manager 202 can fetch (or pre-fetch) the model weights or parameters for a current request (for a subsequent request). As part of the load operation 302, the distributed hierarchical memory manager 202 can load, for the inference task, a set of key and value (KV) entries into at least one of the first-level memory or second-level memory of the distributed memory hierarchy.

In at least one embodiment, the distributed hierarchical memory manager 202 can perform (pre)fetch and evict operations 306 to fetch and evict memory for the inference processor 304 in the operation phase 300. The distributed hierarchical memory manager 202 can also perform operations related to memory and coherency 308 with the set of memory nodes 208 in the operation phase 300. In at least one embodiment, the programmable network device includes an acceleration hardware engine coupled to the processing unit. The acceleration hardware engine can accelerate the operations related to memory and coherency 308 for the inference node by performing zero-copy operations to directly load relevant entries into local memory in the inference processor 304 of the inference node. The hardware acceleration capabilities allow for efficient memory management.

In at least one embodiment, the distributed hierarchical memory manager 202 can selectively load model weights or parameters, KV entries, or other context, based on a task type. The distributed memory hierarchy can be used by the distributed hierarchical memory manager 202 to manage memory more efficiently. In at least one embodiment, the inference processor 304 is a GPU and the distributed hierarchical memory manager 202 can manage the distributed memory hierarchy for the GPU, where only the necessary data is kept in the local inference node, and a policy is used to evict and bring new data to the inference node from the remote nodes as needed. The distributed hierarchical memory manager 202 can rely on pre-defined subsets of weights for specific types of tasks to avoid loading the entire model in the inference node. By managing the distributed memory hierarchy, the distributed hierarchical memory manager 202 can manage memory more efficiently, allowing for the re-use of KV entries across multiple GPUs and users, and implementing policies to determine which nodes act as main memory or cache. For example, the KV entries can be part of active memory in LLMs and used to optimize inference by storing pre-computed values. Also, the KV entries can be cached to reduce the need to re-calculate for each token. The KV entries can be shared between multiple GPUs and users, allowing for efficient reuse of precomputed values and reducing memory requirements.

After the roles of the set of memory nodes 208 are configured, the distributed hierarchical memory manager 202 can handle the coherency protocol and data fetching between memory nodes. In particular, the distributed hierarchical memory manager 202 can be implemented in a DPU or smart NIC that includes hardware that can already handle the coherency protocol and data fetching functionality.

In at least one embodiment, a separate scheduling node can be used to track the availability of model weights or parameters and active memory. The scheduling node could direct requests to the most suitable inference node, optimizing resource management.

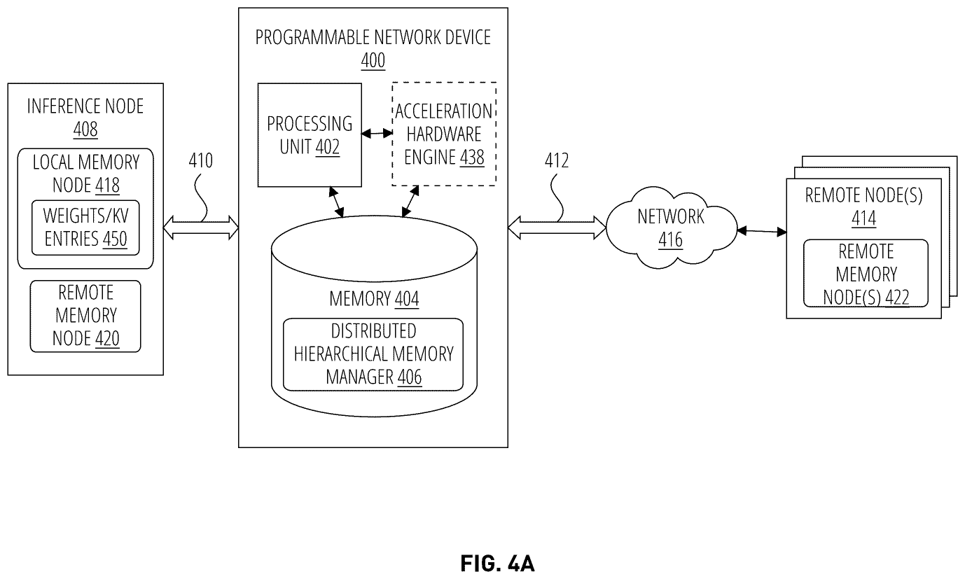

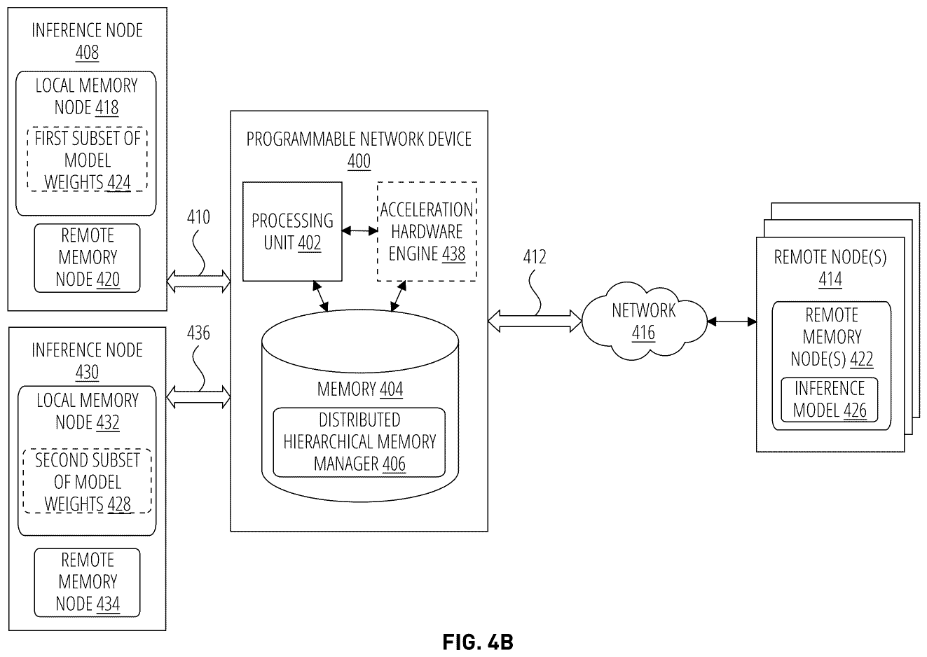

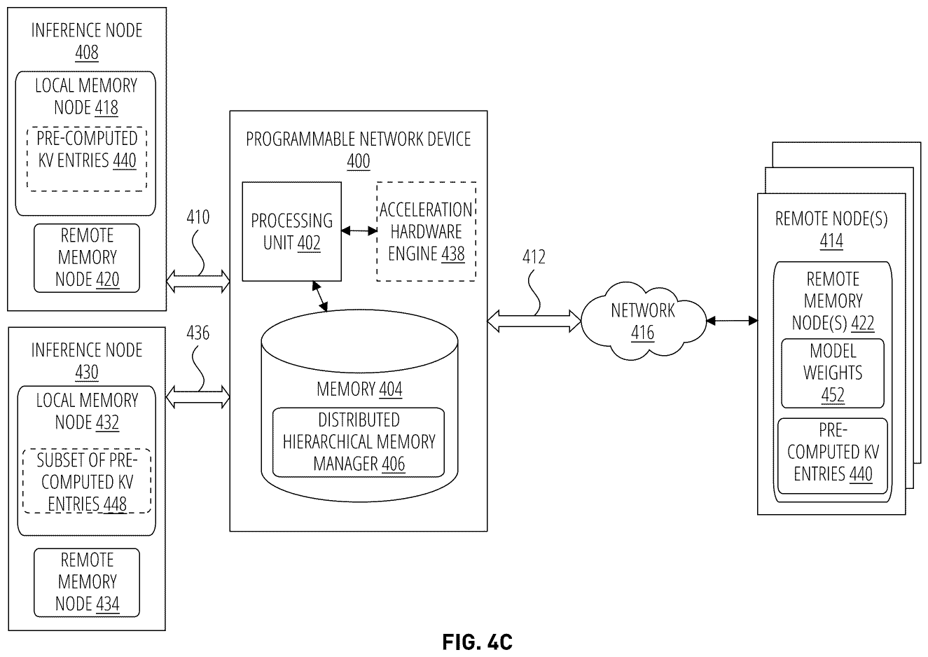

FIG. 4A is a block diagram of a programmable network device 400 with a distributed hierarchical memory manager 406 according to at least one embodiment. In at least one embodiment, the programmable network device 400 includes a processing unit 402, a memory 404, a host interface 410, and a network interface 412. The memory 404 is operatively coupled to the processing unit 402. In at least one embodiment, the memory 404 can store instructions that, when executed by the processing unit, cause the processing unit to operate the distributed hierarchical memory manager 406. The distributed hierarchical memory manager 406 can perform similar operations as the distributed memory logic described herein. The distributed hierarchical memory manager 406 can handle operations related to memory and coherency for an inference engine of the inference node 408. The distributed hierarchical memory manager 406 can create and manage a distributed memory hierarchy, including local memory node 418 and one or more remote memory nodes, including remote memory node 420 on the same inference node 408, and memory nodes 422 on one or more remote node(s) 414. As described herein, the distributed hierarchical memory manager 406 can designate and configure the local memory node 418 to store model weights or parameters and/or KV entries 450 according to the distributed memory hierarchy. In some cases, the distributed hierarchical memory manager 406 can designate and configure the remote memory node 420 to store some of the model weights or parameters and/or KV entries 450.

In at least one embodiment, the inference engine can be an inference processor, such as described herein. The inference engine can be considered a main GPU, where the inference node 408 includes multiple GPUs. The inference node 408 can include local memory associated with the main GPU (e.g., referred to as local GPU memory), as well as memory associated with the other GPUs on the same inference node 408. The memory of the remote memory node 420 can be considered remote memory on the same node as it is remote from the main GPU (i.e., or another inference processor), but still within the inference node 408.

In at least one embodiment, the distributed hierarchical memory manager 406 can receive and process the configuration data to generate a set of rules to manage memory spread across the set of memory nodes (e.g., 418, 420, 422) as part of determining the distributed memory hierarchy. In at least one embodiment, the distributed hierarchical memory manager 406 can configure, according to the set of rules, a second programmable network device attached to each of the one or more remote node(s) 414 as part of configuring each of the remote memory node(s) 422 according to the distributed memory hierarchy. Configuring the second programmable network device can include registering memory regions for model weights or parameters and key and value (KV) entries for zero-copying transfers into the local memory node 418 in an inference processor of the inference node 408. In at least one embodiment, the distributed hierarchical memory manager 406 can devise rules for the distributed memory hierarchy to be able to manage the memory spread across different memory nodes (e.g., 418, 420, 422). An example of the distributed memory hierarchy is illustrated in FIG. 1B, as well as a comparison to a CPU-based memory hierarchy counterpart.

In at least one embodiment, to configure the memory modes, the distributed hierarchical memory manager 406 can configure the programmable network devices attached to various remote memory node(s) 422 according to the rules devised in the previous step. For example, in case of using DPUs, the distributed hierarchical memory manager 406 can register relevant memory regions for model weights and KV cache entries, and later use RDMA operations (e.g., READ/WRITE) to provide a zero-copy mechanism to transfer model weights and key/value state into the local memory node 418 (e.g., GPU memory). Since the weights and contexts are registered beforehand, the programmable network device 400 can receive a request from an inference processor (e.g., GPU), such as a Work Queue Element (WQE). After receiving all relevant content required for the inference node 408 from different memory nodes, the distributed hierarchical memory manager 406 can provide a Completion Queue element (CQE) to the inference processor (e.g., GPU). Alternatively, the requests do not necessarily use WQEs, and the distributed hierarchical memory manager 406 can provide other indications of completion than a CQE. In at least one embodiment, the distributed hierarchical memory manager 406 can receive a WQE, as one of the one or more requests, from the inference processor for content from the set of memory nodes for an inference operation. The distributed hierarchical memory manager 406 can retrieve the content from one of the set of memory nodes, and store the content in local memory node 418 associated with the inference processor (and/or remote memory node 420 on the same inference node 408). The distributed hierarchical memory manager 406 can send a CQE to the inference processor after storing the content in the local memory node 418.

In at least one embodiment, as part of configuring each of the set of memory nodes according to the distributed memory hierarchy, the distributed hierarchical memory manager 406 can configure local memory in an inference processor of the inference node, referred to as the local memory node 418, to operate as first-level memory of the set of memory levels of the distributed memory hierarchy. The distributed hierarchical memory manager 406 can configure the remote memory node 420 in the inference node 408 to operate as second-level memory of the set of memory levels of the distributed memory hierarchy. The distributed hierarchical memory manager 406 can configure remote memory node(s) 422 (e.g., memory in a remote inference node) of the one or more remote node(s) 414 as third-level memory of the set of memory levels of the distributed memory hierarchy. In a further embodiment, the distributed hierarchical memory manager 406 can configure remote memory in a remote memory node (e.g., main memory node 108 of FIG. 1A) of the one or more remote node(s) 414 as fourth-level memory of the set of memory levels of the distributed memory hierarchy.

In at least one embodiment, the distributed hierarchical memory manager 406 can receive the configuration data, determine the distributed memory hierarchy, and configure each of the set of memory nodes in an initialization phase, as described above with respect to FIG. 2. Then, in an operation phase after the initialization phase, such as described above with respect to FIG. 3, the distributed hierarchical memory manager 406 can load, for an inference operation executed by the inference node, a set of model weights or parameters into first-level memory of the set of memory levels of the distributed memory hierarchy. It should be noted that an inference task might contain one or more inference operations. For example, a single request might have to go through multiple inference operations. The distributed hierarchical memory manager 406 can load, for the inference operation, a set of KV entries into at least one of the first-level memory or second-level memory of the set of memory levels of the distributed memory hierarchy. In at least one embodiment, the distributed hierarchical memory manager 406 can allot a certain amount of memory to model weights and KV entries according to the speculated workload and load the respective entries in the memory of various inference nodes. In at least one embodiment, the distributed hierarchical memory manager 406, as part of the operation phase, can allocate a specific amount of memory for model weights or parameters and KV entries in each of the first-level memory and the second-level memory according to an expected workload for the inference operation. It should be noted that the KV entries can be model specific, so the distributed hierarchical memory manager 406 can allocate a specific amount of memory for model weights or parameters and their respective KV entries in each of the first-level memory and the second-level memory.

In at least one embodiment, as part of receiving one or more requests from the inference node over the host interface, the distributed hierarchical memory manager 406 can receive one or more inference requests from an inference processor of the inference node 408 for the inference operation. In at least one embodiment, the memory can be prefetched and evicted according to the inference requests. The distributed hierarchical memory manager 406 can interact with the inference processor (e.g., GPU) to prefetch, fetch, and evict various model weights or KV entries. In other embodiments, the distributed hierarchical memory manager 406 can interact with corresponding programmable network devices (e.g., other DPUs) to prefetch, fetch, and evict the various model weights or KV entries.

In at least one embodiment, as part of interacting with the one or more of the set of memory nodes to perform the memory operations for the inference node 408, the distributed hierarchical memory manager 406 can prefetch, fetch, or evict one or more entries in the set of memory nodes in response to the one or more inference requests for the inference processor. In at least one embodiment, the distributed hierarchical memory manager 406 can handle memory operations and memory coherency for the inference processor. The distributed hierarchical memory manager 406 can interact with various memory nodes to perform these memory operations (e.g., fetch, prefetch, evict, store, store (such as KV entries as described herein)). In cases of storing documents and media, they can be stored explicitly and they are not expected to change very often. In cases of storing chat histories, they can be pushed or written back to the main memory node immediately, or as part of an eviction operation. In other embodiments, the distributed hierarchical memory manager 406 can interact with corresponding programmable network devices (e.g., other DPUs) to perform these memory operations.

In at least one embodiment, the distributed hierarchical memory manager 406 can prefetch the set of model weights or parameters and the set of KV entries from one or more remote memory node(s) 422 located at one or more remote node(s) 414 into local memory nodes located at the inference node 408 (e.g., local memory node 418, remote memory node 420) based on a scheduled inference workload. The distributed hierarchical memory manager 406 can evict unused model weights or parameters from the local memory nodes (e.g., local memory node 418, remote memory node 420) according to the scheduled inference workload. In other embodiments, the distributed hierarchical memory manager 406 can prefetch and evict according to request types.

In at least one embodiment, the programmable network device 400 includes an acceleration hardware engine 438 coupled to the processing unit 402. The acceleration hardware engine 438 can accelerate the fetching and loading the model weights or parameters and/or KV entries 450 into the local memory node 418 by performing zero-copy operations to directly load the model weights or parameters and/or KV entries 450 into the local memory node 418.

As described herein, the distributed hierarchical memory manager 406 can manage domain-specific sub-models for inference according to inference type. An example is illustrated in FIG. 4B with respect to one programmable network device that is coupled to two inference nodes that are executing different inference tasks. In other embodiments, the two inference tasks can be executed by separate inference processors on the same inference node. In other embodiments, the two inference tasks can be executed by the same inference processor at different points in time. In other embodiments, each inference node can be coupled to a separate programmable network device. For ease of description, the programmable network device 400 is coupled to the two inference nodes.

FIG. 4B is a block diagram of the programmable network device 400 with the distributed hierarchical memory manager 406 for managing domain-specific sub-models for inference according to at least one embodiment. In this embodiment, the programmable network device 400 is coupled to the inference node 408 over the host interface 410 and an inference node 430 over a host interface 436. In some cases, the host interface 410 and the host interface 436 can be the same host interface. Like the inference node 408, the inference node 430 includes local memory node 432 and remote memory node 434.

In at least one embodiment, the distributed hierarchical memory manager 406 of the programmable network device 400 receives, from the inference node 408, a first indication of a first inference task being executed by the inference node 408. The distributed hierarchical memory manager 406 can determine, using the first indication of the first inference task, a first inference task type for the first inference task. The distributed hierarchical memory manager 406 can fetch, from the one or more remote node(s) 414 over the network 416, only a first subset of model weights or parameters 424 of an inference model 426. The first subset of model weights or parameters 424 can be associated with the first inference task type. The distributed hierarchical memory manager 406 can load the first subset of model weights or parameters 424 in the local memory node 418 of the inference node 408.

In at least one embodiment, the distributed hierarchical memory manager 406 of the programmable network device 400 receives, from the inference node 430, a second indication of a second inference task being executed by the inference node 430. The distributed hierarchical memory manager 406 can determine, using the second indication of the second inference task, a second inference task type for the second inference task, the second inference task being different than the first inference task. The distributed hierarchical memory manager 406 can fetch, from the one or more remote node(s) 414 over the network 416, only a second subset of model weights or parameters 428 of the inference model 426. The second subset of model weights or parameters being associated with the second inference task type. The distributed hierarchical memory manager 406 can load the second subset of model weights or parameters 428 into local memory node 432 of the inference node 430. In some cases, some of the second subset of model weights or parameters 428 might already be available in the inference node 408, so they can be fetched from there.

In at least one embodiment, the distributed hierarchical memory manager 406 can identify a first pruning mask corresponding to the first inference task type, and a second pruning mask corresponding to the second inference task. The pruning masks can be different task-aware or request-aware pruning masks. These pruning masks can be stored at the programmable network device 400 or at any of the memory nodes described herein. The first pruning mask can identify the first subset of model weights or parameters 424 of the inference model 426. The second pruning mask can identify the second subset of model weights or parameters 428 of the inference model 426. In at least one embodiment, the first pruning mask is a mask for a first programming language, a mask for a second programming language, a mask for a language translation, a mask for logical reasoning and mathematical analysis, or the like. The second pruning mask can be a different one of these masks.

In at least one embodiment, the distributed hierarchical memory manager 406 can receive from the inference node 408, a request for one or more additional model weights or parameters of the inference model 426. The one or more additional model weights or parameters may not be currently stored at the inference node 408. The distributed hierarchical memory manager 406 can fetch, from the one or remote nodes over the network 416 (or the remote memory node 420), the one or more additional model weights or parameters. The distributed hierarchical memory manager 406 can load the one or more additional model weights or parameters into the local memory node 418 of the inference node 408. Similarly, the distributed hierarchical memory manager 406 can receive similar requests from the inference node 430 for the second inference task and fetch and load additional model weights or parameters into the local memory node 432 as needed.

In at least one embodiment, the inference model 426 is stored in any of the remote node(s) 414. In at least one embodiment, the inference model 426 is stored in a remote memory node, such as a designated remote memory node for storing the inference model 426. The remote memory node can store the model weights or parameters of the inference model 426 to enable reusing the model weights or parameters among the different inference nodes, such as the inference node 408 and inference node 430 illustrated in FIG. 4B.

In at least one embodiment, the programmable network device 400 includes an acceleration hardware engine 438 coupled to the processing unit 402. The acceleration hardware engine 438 can accelerate the fetching and loading the first subset of model weights or parameters 424 into the local memory node 418 by performing zero-copy operations to directly load the first subset of model weights or parameters 424 into the local memory node 418. Similarly, the acceleration hardware engine 438 can accelerate the fetching and loading of the second subset of model weights or parameters 428 into the local memory node 432 of the inference node 430.

As described herein, the distributed hierarchical memory manager 406 can manage cached pre-computed KV entries for different inference tasks. In some cases, an inference task can request input context. The input context can be a chat history, additional media (e.g., a PDF document), a portion of the media (e.g., a paragraph selecting using Retrieval-Augmented Generation (RAG) pipeline), etc. The input context can be cached and shared between requests (not intra request). Also, the input context can be considered both intra-user (e.g., the chat history) or inter-user (e.g., employees of the company requiring a common PDF). An example is illustrated in FIG. 4C with respect to one programmable network device that is coupled to two inference nodes that are executing different inference tasks. In other embodiments, the two inference tasks can be executed by separate inference processors on the same inference node. In other embodiments, the two inference tasks can be executed by the same inference processor at different points in time. In other embodiments, each inference node can be coupled to a separate programmable network device. For ease of description, the programmable network device 400 is coupled to the two inference nodes. For ease of description, the programmable network device 400 is coupled to the two inference nodes.

FIG. 4C is a block diagram of the programmable network device 400 with the distributed hierarchical memory manager for managing pre-computed KV entries for an inference task according to at least one embodiment. In this embodiment, the programmable network device 400 is coupled to the inference node 408 over the host interface 410 and the inference node 430 over the host interface 436. In some cases, the host interface 410 and the host interface 436 can be the same host interface.

In at least one embodiment, the distributed hierarchical memory manager 406 can receive, from the inference node 104, a first request to fetch input context for a first inference task being executed by the inference node. The distributed hierarchical memory manager 406 can determine that a set of pre-computed KV entries 440 for the input context are stored in the one or more remote node(s) 414. The set can be a subset or a portion of all KV entries being stored for the input context in the remote memory node(s) 422. The distributed hierarchical memory manager 406 can fetch, from the one or more remote node(s) 414 over the network 416, the set of pre-computed KV entries 440 for the input context. The distributed hierarchical memory manager 406 can load the set of pre-computed KV entries 440 into local memory node 418 of the inference node 408.

In at least one embodiment, the set of pre-computed KV entries 440 is computed in a prefill phase (also referred to as “prefill stage”) of a scaled dot-product attention operation by the inference node 408 using a set of input tokens associated with the first inference task. The programmable network device can receive the first request as part of a subsequent phase to the prefill phase. The subsequent phase can be a decode phase or autoregressive generation phase that uses set of pre-computed KV entries 440 to generate a new token for the set of input tokens. In at least one embodiment, the distributed hierarchical memory manager 406 can receive the first request as part of a prefill phase of a scaled dot-product attention operation by the inference node 408 that uses the set of pre-computed KV entries 440 for all tokens in an input prompt. The distributed hierarchical memory manager 406 can determine that these KV entries have already been pre-computed and stored in one of the memory nodes of the distributed memory hierarchy, such as the remote memory node(s) 422 as illustrated in FIG. 4C. The distributed hierarchical memory manager 406 can fetch the pre-computed KV entries 440 for a given context, such as a PDF file or a portion of the PDF file, which will significantly improve the inference time (i.e., decreases the time in the prefill phase).

In at least one embodiment, the distributed hierarchical memory manager 406 can receive the first request as part of a retrieval step of a Retrieval-Augmented Generation (RAG) pipeline executed by the inference node 408. The set of pre-computed KV entries 440 can be associated with a portion of the input context provided by a vector database. This can accelerate inference time for the RAG pipeline. The distributed hierarchical memory manager 406 can fetch KV entries associated with the portions provided by the vector database. In this embodiment, instead of providing all available context, portions of the available context can be selected by relying on the vector database. For example, KV entries associated with a few relevant paragraphs of a document can be loaded, instead of all KV entries associated with the whole document.

In at least one embodiment, the one or more remote node(s) 414 include a remote memory node that can store model weights or parameters and/or KV entries 450 of an inference model and the set of pre-computed KV entries 440. This enables reusing the model weights or parameters and/or KV entries model weights or parameters 452 and the pre-computed KV entries 440 among inference requests from the inference node 408 or among inference requests from multiple inference nodes, such as the inference node 408 and inference node 430. As illustrated in FIG. 4C, the distributed hierarchical memory manager 406 can receive a request from an inference task being executed by the inference node 430. The first request can be for input context for the second inference task. The distributed hierarchical memory manager 406 can determine that the set of pre-computed KV entries 440 for the input context are stored in the remote memory node(s) 422. The distributed hierarchical memory manager 406 can fetch, from the one or more remote node(s) 414 over the network 416, the set of pre-computed KV entries 440 for the input context. The distributed hierarchical memory manager 406 can load the pre-computed KV entries 440 into the remote memory node 434 of the inference node 430.

In at least one embodiment, the distributed hierarchical memory manager 406 can load, for an inference operation, a set of pre-computed KV entries 440 into at least one of the first-level memory or second-level memory of the set of memory levels of the distributed memory hierarchy. In at least one embodiment, the distributed hierarchical memory manager 406 can allot a certain amount of memory to model weights and pre-computed KV entries 440 according to the speculated workload and load the respective entries in the memory of various inference nodes. In at least one embodiment, the distributed hierarchical memory manager 406, as part of the operation phase, can allocate a specific amount of memory for model weights or parameters and KV entries in each of the first-level memory and the second-level memory according to an expected workload for the inference operation.

In at least one embodiment, as part of receiving one or more requests from the inference node over the host interface, the distributed hierarchical memory manager 406 can receive one or more inference requests from an inference processor of the inference node 408 for the inference operation. In at least one embodiment, the memory can be prefetched and evicted according to the inference requests. The distributed hierarchical memory manager 406 can interact with the inference processor (e.g., GPU) to prefetch, fetch, and evict various model weights or parameters 452 or pre-computed KV entries 440. In other embodiments, the distributed hierarchical memory manager 406 can interact with corresponding programmable network devices (e.g., other DPUs) to prefetch, fetch, and evict the various model weights or parameters 452 or pre-computed KV entries 440.

In at least one embodiment, as part of interacting with the one or more of the set of memory nodes to perform the memory operations for the inference node 408, the distributed hierarchical memory manager 406 can prefetch, fetch, or evict one or more pre-computed KV entries 440 in the set of memory nodes in response to the one or more inference requests for the inference processor. In at least one embodiment, the distributed hierarchical memory manager 406 can handle memory operations and memory coherency for the inference processor. The distributed hierarchical memory manager 406 can interact with various memory nodes to perform these memory operations (e.g., fetch, prefetch, evict). In other embodiments, the distributed hierarchical memory manager 406 can interact with corresponding programmable network devices (e.g., other DPUs) to perform these memory operations.

In at least one embodiment, the distributed hierarchical memory manager 406 can prefetch the model weights or parameters 452 and the set of pre-computed KV entries 440 from one or more remote memory node(s) 422 located at one or more remote node(s) 414 into local memory nodes located at the inference node 408 (e.g., local memory node 418, remote memory node 420) based on a scheduled inference workload. The distributed hierarchical memory manager 406 can evict unused model weights or parameters and unused KV entries from the local memory nodes (e.g., local memory node 418, remote memory node 420) according to the scheduled inference workload. In other embodiments, the distributed hierarchical memory manager 406 can prefetch and evict according to request types.

In at least one embodiment, the programmable network device 400 includes the acceleration hardware engine 438 coupled to the processing unit 402. The acceleration hardware engine 438 can accelerate the fetching and loading the model weights or parameters 452 and/or pre-computed KV entries 440 into the local memory node 418 by performing zero-copy operations to directly load the model weights or parameters 452 and pre-computed KV entries 440 into the local memory node 418.

In some embodiments, the programmable network device 400 can also be configured to store some of the pre-computed KV entries 440 that are calculated during the prefill phase. One example could be a chat history, where the generated KV entries for a user might be re-used later in the future. These KV entries could be stored in memory of the programmable network device 400. The generated KV entries stored at the programmable network device 400 could be other types of context used during a subsequent phase, such as a decode phase or autoregressive generation phase.

In at least one embodiment, a system for performing inference operations can include an inference node, a remote node, the programmable network device 400 coupled to the inference node and the remote node. The inference node includes a main GPU with local GPU memory, and zero or more additional GPUs with corresponding additional memory. The remote node include remote memory. The programmable network device 400 can include a processing unit, a memory unit, a host interface, and a network interface communicatively coupled together. The memory can store instructions that, when executed by the processing unit, cause the processing unit to perform various operations. The processing unit can receive configuration data identifying a set of memory nodes, each memory node located at the inference node or the remote node. The set of memory nodes includes the local GPU memory, the additional memory, and the remote memory. The processing unit can determine, using the configuration data, a distributed memory hierarchy that organizes the set of memory nodes into a set of memory levels for the main GPU. The processing unit can configure each of the set of memory nodes according to the distributed memory hierarchy. The processing unit can receive one or more requests from the main GPU over the host interface, and interact with one or more of the set of memory nodes to perform memory operations for the main GPU. In a further embodiment, the processing unit includes a CPU, a GPU, a DPU, a network adapter, a network switch, or an NVLink switch.

In at least one embodiment, the programmable network device 400 can include distributed hierarchical memory manager or distributed memory logic as described herein. The programmable network device 400 can provide an interface to the inference node that enables the inference node to fetch or evict entries at any of the set of memory levels of the distributed memory hierarchy. In at least one embodiment, the programmable network device 400 can provide a first interface to an administrator that enables the administrator to define and configure the distributed memory hierarchy, and a second interface to the inference engine that enables that enables the inference engine to fetch or evict entries at any of the plurality of memory levels of the distributed memory hierarchy. In other embodiments, the programmable network device 400 can provide these interfaces as application programming interfaces (APIs).

In at least one embodiment, the programmable network device 400 can operate in two main phases (i) initialization phase where it receives a configuration from a user (i.e., a system administrator) to configure the distributed memory for inference operations, and (ii) operation phase where it interacts with an inference engine (or main GPU) to fetch or store different entries (e.g., model weights/parameters or KV entries).

In at least one embodiment, the remote memory mode can be a main memory node that stores model weights or parameters and KV entries of an interference model to enable reusing the set of model weights or parameters and the set of KV entries among the inference node and one or more remote inference nodes.

In at least one embodiment, the programmable network device 400 can determine an inference task type for an inference task executed by the inference node. The programmable network device 400 can identify a pruning mask corresponding to the inference task type. The programmable network device 400 can load a subset of the model weights or parameters into the first-level memory, and load a subset of the KV entries into at least one of the first-level memory or the second-level memory. In some embodiments, the programmable network device 400 can support other task-aware or request-type-aware inference operations to be able to only fetch relevant model weights into the local memory of an inference node.

In at least one embodiment, the programmable network device 400 include the acceleration hardware engine 438 to accelerate operations related to memory and coherency for the inference node. In at least one embodiment, the acceleration hardware engine 438 can perform zero-copy operations to directly load relevant entries into local GPU memory in a main GPU of the inference node. Accelerating memory management using the programmable network devices programmable network device 400 (e.g., DPU) makes it possible to perform zero-copy and directly load the relevant entries into the GPU memory without any additional PCIe overhead. Moreover, it makes it possible to remove CPU from the memory nodes and create DPU-attached memory nodes.

Using a distributed memory for inference not only increases the capacity of local inference memory, but also enables request parallelization, as different requests can still reuse their previously calculated KV cache entries without re-computing them (i.e., evicting them to a remote memory instead of discarding them). In at least one embodiment, the distributed memory hierarchy increases a capacity of local inference memory for the inference node. In at least one embodiment, the distributed memory hierarchy enables request parallelization.

In at least one embodiment, the programmable network device 400 can receive the configuration data 204 as described herein.

In at least one embodiment, the programmable network device 400 include a processing device, an acceleration hardware engine, and memory storing instructions. The instructions, when executed by the processing device and the acceleration hardware engine perform the various operations described herein.

In at least one embodiment, a computing system includes a main memory node, a first node assigned as a current inference node, a second node, and the programmable network device 400. The first node includes a main GPU including GPU memory, one or more additional GPUs, each GPU including GPU memory. The second node includes a set of one or more GPUs, each including GPU memory. The programmable network device 400 is operatively coupled to the main memory mode, the first node, and the second node. The programmable network device 400 can include a processing unit and memory operatively coupled to the processing unit. The memory to store instructions that, when executed by the processing unit, cause the processing unit to perform the various operations described herein.

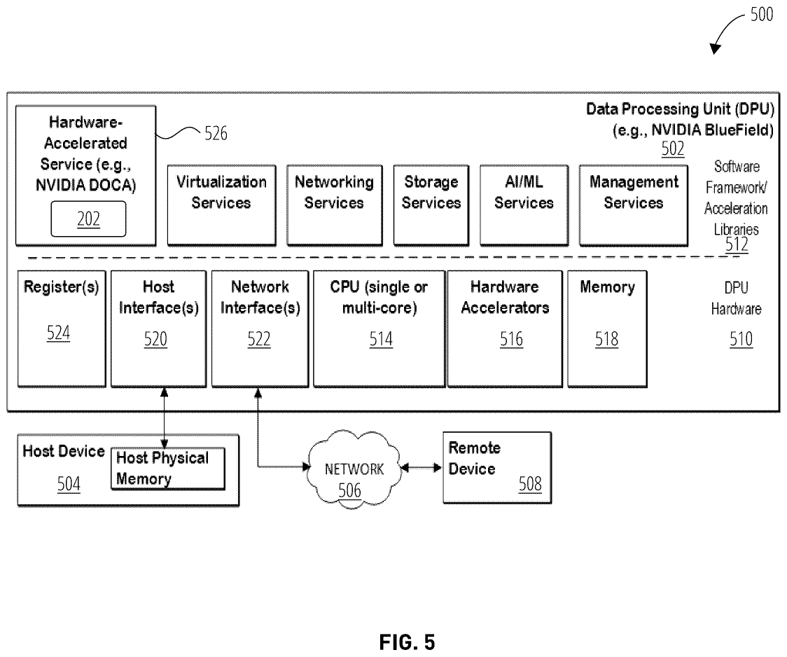

In at least one embodiment, the programmable network device 400 is a DPU, including DPU hardware and DPU software, such as illustrated and described below with respect to FIG. 5.

### DPU System Architechture

FIG. 5 is a block diagram of an example system architecture 500 of a data processing unit (DPU) with a distributed hierarchical memory manager 202, according to at least one embodiment. The system architecture 500 (also referred to as “system” or “computing system” herein) includes an integrated circuit, labeled DPU 502, a host device 504, and a remote node 508. The DPU 502 is coupled to the remote node 508 over a network 506. The system architecture 500 can be part of a data center and include one or more data stores, one or more server machines, and other components of data center infrastructure. In implementations, network 506 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

In at least one embodiment, DPU 502 is integrated as a System on a Chip (SoC) that is considered a data center infrastructure on a chip. In at least one embodiment, DPU 502 includes DPU hardware 510 and software framework with acceleration libraries 512. The DPU hardware 510 can include a CPU 514 (e.g., a single-core or multi-core CPU), one or more hardware accelerators 516, memory 518, one or more host interface(s) 520, one or more network interface(s) 522, and one or more register(s) 524. The software framework and acceleration libraries 512 can include one or more hardware-accelerated services, including hardware-accelerated service 526 (e.g., NVIDIA DOCA), hardware-accelerated virtualization services, hardware-accelerated networking services, hardware-accelerated storage services, hardware-accelerated artificial intelligence/machine learning (AI/ML) services, and hardware-accelerated management services. The hardware-accelerated service 526 can implement the distributed hierarchical memory manager 202 described herein. In at least one embodiment, DPU 502 is coupled to an accelerated AI/ML pipeline that implements the distributed hierarchical memory manager 202. In at least one embodiment, the accelerated AI/ML pipeline can be a GPU coupled to the DPU 502 for additional computational power.

The host device 504 can include host physical memory. The host physical memory can include one or more volatile and/or non-volatile memory devices that are configured to store the data of host device 504.

It should be noted that, unlike a CPU or GPU, DPU 502 is a new class of programmable processor that combines three key elements, including, for example: 1) an industry-standard, high-performance, software-programmable CPU (single-core or multi-core CPU), tightly coupled to the other SoC components; 2) a high-performance network interface capable of parsing, processing and efficiently transferring data at line rate, or the speed of the rest of the network, to GPUs and CPUs; and 3) a rich set of flexible and programmable acceleration engines that offload and improve applications performance for AI and machine learning, security, telecommunications, and storage, among others. These capabilities can enable an isolated, bare-metal, cloud-native computing platform for cloud-scale computing. In at least one embodiment, DPU 502 can be used as a stand-along embedded processor. In at least one embodiment, DPU 502 can be incorporated into a network interface controller (also called a Smart Network Interface Card (SmartNIC)) used as a server system component. A DPU-based network interface card (network adapter) can offload processing tasks that the server system's CPU normally handles. Using its processor, a DPU-based SmartNIC may be able to perform any combination of encryption/decryption, firewall, transport control protocol/Internet Protocol (TCP/IP), and HyperText Transport Protocol (HTTP) processing. SmartNICs can be used for high-traffic web servers, for example.

In at least one embodiment, DPU 502 can be configured for traditional enterprises'modern cloud workloads and high-performance computing. In at least one embodiment, DPU 502 can deliver a set of software-defined networking, storage, security, and management services (e.g., hardware-accelerated service 526 and others) at a data-center scale with the ability to offload, accelerate, and isolate data center infrastructure. In at least one embodiment, DPU 502 can provide multi-tenant, cloud-native environments with these software services. In at least one embodiment, DPU 502 can deliver data center services of up to hundreds of CPU cores, freeing up valuable CPU cycles to run business-critical applications. In at least one embodiment, DPU 502 can be considered a new type of processor that is designed to process data center infrastructure software to offload and accelerate compute load of virtualization, networking, storage, security, cloud-native AI/ML services, and other management services.

In at least one embodiment, DPU 502 can include connectivity with packet-based interconnects (e.g., Ethernet), switched-fabric interconnects (e.g., InfiniBand, Fibre Channels, Omni-Path), or the like. In at least one embodiment, DPU 502 can provide a data center that is accelerated, fully programmable, and configured with security (e.g., zero-trust security) to prevent data breaches and cyberattacks. In at least one embodiment, DPU 502 can include a network adapter, an array of processor cores, and infrastructure offload engines with full software programmability. In at least one embodiment, DPU 502 can sit at an edge of a server to provide flexible, secured, high-performance cloud and AI workloads. In at least one embodiment, DPU 502 can reduce the total cost of ownership and increase data center efficiency. In at least one embodiment, DPU 502 can provide the software framework and acceleration libraries 512 (e.g., NVIDIA DOCA™) that enables developers to rapidly create applications and services for DPU 502, such as hardware-accelerated service 526, virtualization services, networking services, storage services, AI/ML services, and management services. In at least one embodiment, the distributed hierarchical memory manager 202 is implemented in the AI/ML services. In another embodiment, the distributed hierarchical memory manager 202 is implemented on one or more hardware accelerators 516, CPU 514, or other components of the DPU hardware 510. In at least one embodiment, the software framework and acceleration libraries 512 makes it easy to leverage hardware accelerators of DPU 502 to provide data center performance, efficiency, and security. In at least one embodiment, the distributed hierarchical memory manager 202 is implemented in a GPU coupled to the DPU 502. The GPU can include the one or more accelerated pipeline described herein.

In at least one embodiment, DPU 502 can provide networking services with a virtual switch (vSwitch), a virtual router (vRouter), network address translation (NAT), load balancing, and network virtualization (NFV). In at least one embodiment, DPU 502 can provide storage services, including NVME™ over fabrics (NVMe-oF™) technology, elastic storage virtualization, hyper-converged infrastructure (HCI) encryption, data integrity, compression, data deduplication, or the like. NVM Express™ is an open logical device interface specification for accessing non-volatile storage media attached via the PCI Express® (PCIe) interface. NVMe-oF™ provides an efficient mapping of NVMe commands to several network transport protocols, enabling one computer (an “initiator”) to access block-level storage devices attached to another computer (a “target”) very efficiently and with minimum latency. The term “Fabric” is a generalization of the more specific ideas of network and input/output (I/O) channel. It essentially refers to an N:M interconnection of elements, often in a peripheral context. The NVMe-oF™ technology enables the transport of the NVMe command set over a variety of interconnection infrastructures, including networks (e.g., Internet Protocol (IP)/Ethernet) and also I/O Channels (e.g., Fibre Channel). In at least one embodiment, DPU 502 can provide hardware-accelerated services using Next-Generation Firewall (FGFW), Intrusion Detection Systems (IDS), Intrusion Prevention System (IPS), a root of trust, micro-segmentation, and distributed denial-of-service (DDoS) prevention technologies. NGFW is a network security device that provides capabilities beyond a stateful firewall, like application awareness and control, integrated intrusion prevention, and cloud-delivered threat intelligence. In at least one embodiment, the one or more network interface(s) 522 can include an Ethernet interface (single or dual ports) and an InfiniBand interface (single or dual ports). In at least one embodiment, the one or more host interface(s) 520 can include a PCIe interface and a PCIe switch. In at least one embodiment, the one or more host interface(s) 520 can include other memory interfaces. In at least one embodiment, CPU 514 can include multiple cores (e.g., up to 8 64-bit core pipelines) with L2 cache per two one or two cores and L3 cache with eviction policies support for double data rate (DDR) dual in-line memory module (DIMM) (e.g., DDR4 DIMM support), and a DDR4 DRAM controller. Memory 518 can be on-board DDR4 memory with error correction code (ECC) error protection support. In at least one embodiment, CPU 514 can include a single core with L2 and L3 caches and a DRAM controller. In at least one embodiment, the one or more hardware accelerators 516 can include a security accelerator, a storage accelerator, and a networking accelerator. In at least one embodiment, a security accelerator can provide a secure boot with hardware root-of-trust, secure firmware updates, Cerberus compliance, Regular expression (RegEx) acceleration, IP security (IPsec)/Transport Layer Security (TLS) data-in-motion encryption, AES-GCM 128/256-bit key for data-at-rest encryption (e.g., Advanced Encryption Standard (AES) with ciphertext stealing (XTS) (e.g., AES-XTS 256/512), secure hash algorithm (SHA) 256-bit hardware acceleration, Hardware public key accelerator (e.g., Rivest-Shamir-Adleman (RSA), Diffie-Hellman, Digital Signal Algorithm (DSA), ECC, Elliptic Curve Cryptography Digital Signal Algorithm (EC-DSA), Elliptic-curve Diffie-Hellman (EC-DH)), and True random number generator (TRNG). In at least one embodiment, the storage accelerator can provide BlueField SNAP—NVMe™ and VirtIO-blk, NVMe-oF™ acceleration, compression and decompression acceleration, and data hashing and deduplication. In at least one embodiment, the network accelerator can provide remote direct memory access (RDMA) over Converged Ethernet (RoCE) RoCE, Zero Touch RoCE, Stateless offloads for TCP, IP, and User Datagram Protocol (UDP), Large Receive Offload (LRO), Large Segment Offload (LSO), checksum, Total Sum of Squares (TSS), Residual Sum of Squares (RSS), HTTP dynamic streaming (HDS), and virtual local area network (VLAN) insertion/stripping, single root I/O virtualization (SR-IOV), virtual Ethernet card (e.g., VirtIO-net), Multi-function per port, VMware NetQueue support, Virtualization hierarchies, and ingress and egress Quality of Service (QoS) levels (e.g., 1K ingress and egress QoS levels). In at least one embodiment, DPU 502 can also provide boot options, including secure boot (RSA authenticated), remote boot over Ethernet, remote boot over Internet Small Computer System Interface (iSCSI), Preboot execution environment (PXE), and Unified Extensible Firmware Interface (UEFI).

In at least one embodiment, DPU 502 can provide management services, including a 1GbE out-of-band management port, network controller sideband interface (NC-SI), Management Component Transport Protocol (MCTP) over System Management Bus (SMBus), and Monitoring Control Table (MCT) over PCIe, Platform Level Data Model (PLDM) for Monitor and Control, PLDM for Firmware Updates, Inter-Integrated Circuit (I2C) interface for device control and configuration, Serial Peripheral Interface (SPI) interface to flash, embedded multi-media card (eMMC) memory controller, Universal Asynchronous Receiver/Transmitter (UART), and Universal Serial Bus (USB).

Host device 504 may be a desktop computer, a laptop computer, a smartphone, a tablet computer, a server, or any suitable computing device capable of performing the techniques described herein. In some embodiments, host device 504 may be a computing device of a cloud-computing platform. For example, host device 504 may be a server machine of a cloud-computing platform or a component of the server machine. In such embodiments, host device 504 may be coupled to one or more edge devices (not shown) via network 506. An edge device refers to a computing device that enables the communication between computing devices at the boundary of two networks. For example, an edge device may be connected to host device 504, one or more data stores, one or more server machines via network 506, and may be connected to one or more endpoint devices (not shown) via another network. In such an example, the edge device can enable communication between host device 504, one or more data stores, one or more server machines, and one or more client devices. In other or similar embodiments, host device 504 may be an edge device or a component of an edge device. For example, host device 504 may facilitate communication between one or more data stores, one or more server machines connected to host device 504 via network 506, and one or more client devices connected to host device 504 via another network.

In still other or similar embodiments, host device 504 can be an endpoint device or a component of an endpoint device. For example, host device 504 may be, or may be a component of, devices, such as televisions, smart phones, cellular telephones, data center servers, data DPUs, personal digital assistants (PDAs), portable media players, netbooks, laptop computers, electronic book readers, tablet computers, desktop computers, set-top boxes, gaming consoles, a computing device for autonomous vehicles, a surveillance device, and the like. In such embodiments, host device 504 may be connected to DPU 502 over one or more network interface(s) 522 via network 506. In other or similar embodiments, host device 504 may be connected to an edge device (not shown) via another network, and the edge device may be connected to DPU 502 via network 506.

In at least one embodiment, the host device 504 executes one or more computer programs. One or more computer programs can be any process, routine, or code executed by the host device 504, such as a host OS, an application, a guest OS of a virtual machine, or a guest application, such as executed in a container. Host device 504 can include one or more CPUs of one or more cores, one or more multi-core CPUs, one or more GPUs, one or more hardware accelerators, or the like.

In at least one embodiment, one or more computer programs reside in a first computing domain (e.g., a host domain), and hardware-accelerated service 526 and distributed hierarchical memory manager 202 reside in a second computing domain (e.g., DPU domain or infrastructure domain) different than the first computing domain. In at least one embodiment, DPU 502 includes a direct memory access (DMA) controller (not illustrated in FIG. 5) coupled to host interface(s) 520. The DMA controller can read the data from host physical memory via host interface(s) 520. In at least one embodiment, the DMA controller reads data from host physical memory using the PCIe technology. Alternatively, other technologies can be used to read data from host physical memory.

Although various embodiments described above are directed to embodiments where the distributed hierarchical memory manager 202 are implemented in the hardware-accelerated service 526, in other embodiments, operations can be performed by any computing system or computing device capable of performing the techniques described herein.

In at least one embodiment, the DPU 502 is the programmable network device 126 of FIG. 1A. In at least one embodiment, the DPU 502 is programmable network device 400 of FIG. 4A. In at least one embodiment, the DPU 502 includes distributed memory logic (hardware, software, or any combination thereof). The distributed memory logic can receive configuration data identifying a set of memory nodes, each memory node located at an inference node (host device 504) or at one or more remote nodes 508. The distributed memory logic can determine, using the configuration data, a distributed memory hierarchy that organizes the set of memory nodes into a set of memory levels for the inference node. The distributed memory logic can configure each of the set of memory nodes according to the distributed memory hierarchy. Once configured, the distributed memory logic can receive one or more requests from the inference node (e.g., host device 504) over a host interface (e.g., host interface(s) 520) and interact with one or more of the set of memory nodes over a network interface (e.g., network interface(s) 522) to perform memory operations for the inference node.

In at least one embodiment, the DPU 502 includes a processing unit (e.g., CPU 514), memory operatively coupled to the processing unit. The memory can store instructions that, when executed by the processing unit, cause the processing unit to operate the distributed memory logic as software (e.g., distributed hierarchical memory manager 202) to handle operations related to memory and coherency for an inference engine of the inference node.

In at least one embodiment, the distributed memory logic can process the configuration data to generate a set of rules to manage memory spread across the set of memory nodes as part of determining the distributed memory hierarchy. In at least one embodiment, the distributed memory logic can configure, according to the set of rules, a second programmable network device attached to each of the one or more remote nodes as part of configuring each of the plurality of memory nodes according to the distributed memory hierarchy. Configuring the second programmable network device can include registering memory regions for model weights or parameters and key and value (KV) entries for zero-copying transfers into local memory in an inference processor of the inference node. In at least one embodiment, the distributed memory logic can devise rules for the distributed memory hierarchy to be able to manage the memory spread across different memory nodes. An example of the distributed memory hierarchy is illustrated in FIG. 1B, as well as a comparison to a CPU-based memory hierarchy counterpart.

In at least one embodiment, to configure the memory modes, the distributed memory logic can configure the programmable network devices attached to various memory nodes according to the rules devised in the previous step. For example, in case of using DPUs, the distributed memory logic can register relevant memory regions for model weights and KV cache entries, and later use RDMA operations (e.g., READ/WRITE) to provide a zero-copy mechanism to transfer model weights and key/value state into the local memory (e.g., GPU memory). Since the weights and contexts are registered beforehand, the DPU 502 can receive a request from an inference processor (e.g., GPU), such as a WQE. After receiving all relevant content required for the inference node from different memory nodes, the distributed memory logic can provide a CQE to the inference processor (e.g., GPU). Alternatively, the requests do not necessarily use WQEs, and the distributed memory logic can provide other indications of completion than a CQE. In at least one embodiment, the distributed memory logic can receive a WQE, as one of the one or more requests, from the inference processor for content from the set of memory nodes for an inference operation. The distributed memory logic can retrieve the content from one of the set of memory nodes, and store the content in local memory associated with the inference processor. The distributed memory logic can send a CQE to the inference processor after storing the content in the local memory. In at least one embodiment, as part of configuring each of the set of memory nodes according to the distributed memory hierarchy, the distributed memory logic can configure local memory in an inference processor of the inference node to operate as first-level memory of the set of memory levels of the distributed memory hierarchy, configure remote memory in the inference node to operate as second-level memory of the set of memory levels of the distributed memory hierarchy, and configure remote memory in a remote inference node of the one or more remote nodes as third-level memory of the set of memory levels of the distributed memory hierarchy. In a further embodiment, the distributed memory logic can configure remote memory in a remote memory node of the one or more remote nodes as fourth-level memory of the set of memory levels of the distributed memory hierarchy.

In at least one embodiment, the distributed memory logic can receive the configuration data, determine the distributed memory hierarchy, and configure each of the set of memory nodes in an initialization phase, as described above with respect to FIG. 2. Then, in an operation phase after the initialization phase, such as described above with respect to FIG. 3, the distributed memory logic can load, for an inference operation executed by the inference node, a set of model weights or parameters into first-level memory of the set of memory levels of the distributed memory hierarchy. It should be noted that an inference task might contain one or more inference operations. For example, a single request might have to go through multiple inference operations. The distributed memory logic can load, for the inference operation, a set of KV entries into at least one of the first-level memory or second-level memory of the set of memory levels of the distributed memory hierarchy. In at least one embodiment, the distributed memory logic can allot a certain amounts of various memories to model weights and KV entries according to the speculated workload and load the respective entries in the memory of various inference nodes. In at least one embodiment, the distributed memory hierarchies, as part of the operation phase, can allocate a specific amount of memory for model weights or parameters and KV entries in each of the first-level memory and the second-level memory according to an expected workload for the inference operation.

In at least one embodiment, as part of receiving one or more requests from the inference node over the host interface, the distributed memory logic can receive one or more inference requests from an inference processor of the inference node for the inference operation. In at least one embodiment, the memory can be prefetched and evicted according to the inference requests. The distributed memory logic can interact with the inference processor (e.g., GPU) to prefetch, fetch, and evict various model weights or KV entries. In other embodiments, the distributed memory logic can interact with corresponding programmable network devices (e.g., other DPUs) to prefetch, fetch, and evict the various model weights or KV entries.

In at least one embodiment, as part of interacting with the one or more of the set of memory nodes to perform the memory operations for the inference node, the distributed memory logic can prefetch, fetch, or evict one or more entries in the set of memory nodes in response to the one or more inference requests for the inference processor. In at least one embodiment, the distributed memory logic can handle memory operations and memory coherency for the inference processor. The distributed memory logic can interact with various memory nodes to perform these memory operations (e.g., fetch, prefetch, evict). In other embodiments, the distributed memory logic can interact with corresponding programmable network devices (e.g., other DPUs) to perform these memory operations.

In at least one embodiment, the distributed memory logic can prefetch the set of model weights or parameters and the set of KV entries from one or more memory nodes located at one or more remote nodes into local memory nodes located at the inference node based on a scheduled inference workload. The distributed memory logic can evict unused model weights or parameters from the local memory nodes according to the scheduled inference workload. In other embodiments, the distributed memory logic can prefetch and evict according to request types.

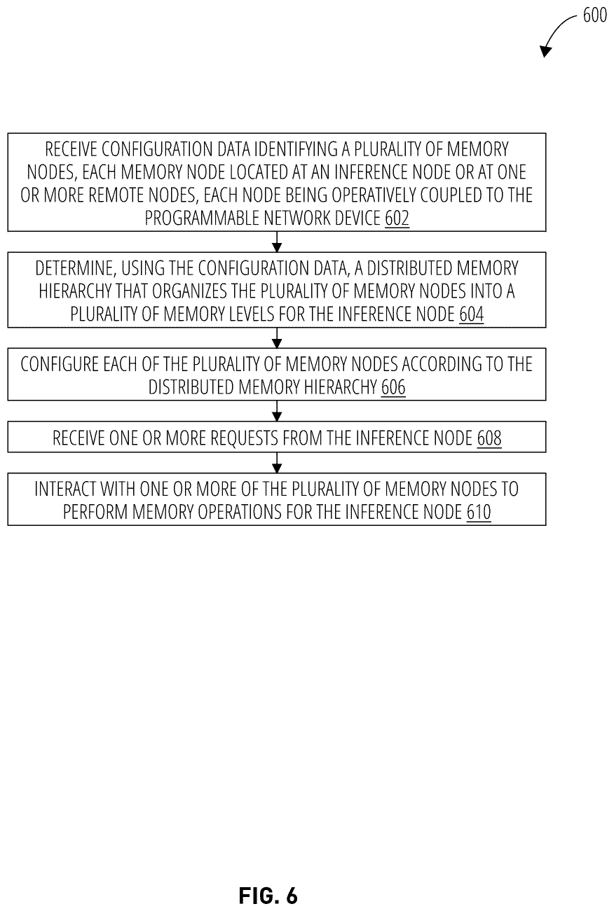

FIG. 6 is a flow diagram of a method 600 for managing a distributed memory hierarchy according to at least one embodiment. The method 600 can be performed using one or more processing units (e.g., CPUs, GPUs, accelerators, physics processing units (PPUs), data processing units (DPUs), etc.), which may include (or communicate with) one or more memory devices. In at least one embodiment, the method 600 can be performed using a processing device or processing devices. In at least one embodiment, the method 600 can be performed using one or more processing units of a component of FIG. 1A. In at least one embodiment, the method 600 can be performed using one or more processing units of a component of FIG. 2 or FIG. 3. In at least one embodiment, the method 600 can be performed using one or more processing units of a component of FIG. 5. In at least one embodiment, processing units performing the method 600 can be executing instructions stored on a non-transient computer readable storage media. In at least one embodiment, the method 600 can be performed using multiple processing threads (e.g., CPU threads and/or GPU threads), individual threads executing one or more individual functions, routines, subroutines, or operations of the method. In at least one embodiment, processing threads implementing the method 600 can be synchronized (e.g., using semaphores, critical sections, and/or other thread synchronization mechanisms). Alternatively, processing threads implementing the method 600 can be executed asynchronously with respect to each other. Various operations of the method 600 can be performed in a different order compared with the order shown in FIG. 6. Some operations of the method 600 can be performed concurrently with other operations. In at least one embodiment, one or more operations shown in FIG. 6 may not always be performed.

At block 602, the one or more processing units executing method 600 can receive configuration data identifying a plurality of memory nodes, each memory node located at an inference node or at one or more remote nodes, each node being operatively coupled to the programmable network device. At block 604, the one or more processing units executing method 600 can determine, using the configuration data, a distributed memory hierarchy that organizes the plurality of memory nodes into a plurality of memory levels for the inference node. At block 606, the one or more processing units executing method 600 can configure each of the plurality of memory nodes according to the distributed memory hierarchy. At block 608, the one or more processing units executing method 600 can receive one or more requests from the inference node. At block 610, the one or more processing units executing method 600 can interact with one or more of the plurality of memory nodes to perform memory operations for the inference node.

In a further embodiment, the one or more processing units executing method 600 can determine the distributed memory hierarchy comprises processing the configuration data to generate a set of rules to manage memory spread across the plurality of memory nodes according to the distributed memory hierarchy. The one or more processing units executing method 600 can configure each of the plurality of memory nodes according to the distributed memory hierarchy. The one or more processing units executing method 600 can configure, according to the set of rules, a second programmable network device attached to each of the one or more remote nodes. The one or more processing units executing method 600 can register memory regions for model weights or parameters entries for zero-copying transfers into local memory in an inference processor of the inference node. The one or more processing units executing method 600 can perform other operations described herein.

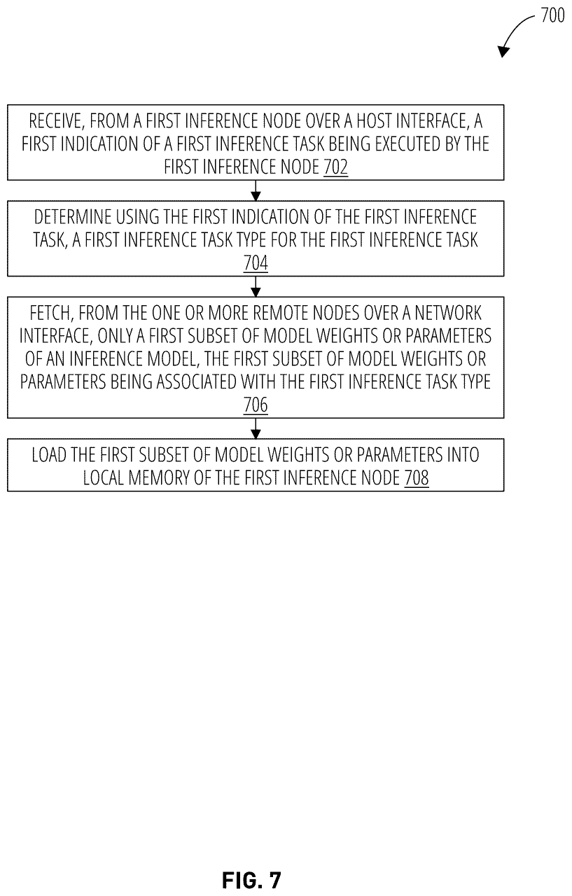

FIG. 7 is a flow diagram of a method 700 for managing a distributed memory hierarchy according to at least one embodiment. The method 700 can be performed using one or more processing units (e.g., CPUs, GPUs, accelerators, physics processing units (PPUs), data processing units (DPUs), etc.), which may include (or communicate with) one or more memory devices. In at least one embodiment, the method 700 can be performed using a processing device or processing devices. In at least one embodiment, the method 700 can be performed using one or more processing units of a component of FIG. 1A. In at least one embodiment, the method 700 can be performed using one or more processing units of a component of FIG. 2 or FIG. 3. In at least one embodiment, the method 700 can be performed using one or more processing units of a component of FIG. 5. In at least one embodiment, processing units performing the method 700 can be executing instructions stored on a non-transient computer readable storage media. In at least one embodiment, the method 700 can be performed using multiple processing threads (e.g., CPU threads and/or GPU threads), individual threads executing one or more individual functions, routines, subroutines, or operations of the method. In at least one embodiment, processing threads implementing the method 700 can be synchronized (e.g., using semaphores, critical sections, and/or other thread synchronization mechanisms). Alternatively, processing threads implementing the method 700 can be executed asynchronously with respect to each other. Various operations of the method 700 can be performed in a different order compared with the order shown in FIG. 7. Some operations of the method 700 can be performed concurrently with other operations. In at least one embodiment, one or more operations shown in FIG. 7 may not always be performed.

At block 702, the one or more processing units executing method 700 receives, from a first inference node over a host interface, a first indication of a first inference task being executed by the first inference node. At block 704, the one or more processing units executing method 700 determines using the first indication of the first inference task, a first inference task type for the first inference task. At block 706, the one or more processing units executing method 700 fetches, from the one or more remote nodes over a network interface, only a first subset of model weights or parameters of an inference model, the first subset of model weights or parameters being associated with the first inference task type. At block 708, the one or more processing units executing method 700 loads the first subset of model weights or parameters into local memory of the first inference node.

In a further embodiment, the one or more processing units executing method 700 receives, from a second inference node, a second indication of a second inference task being executed by the second inference node. The one or more processing units executing method 700 determines, using the second indication of the second inference task, a second inference task type for the second inference task, the second inference task being different than the first inference task. The one or more processing units executing method 700 fetches, from the one or more remote nodes over the network interface, only a second subset of model weights or parameters of the inference model, the second subset of model weights or parameters being associated with the second inference task type. The one or more processing units executing method 700 loads the second subset of model weights or parameters into local memory of the second inference node.

In a further embodiment, the one or more processing units executing method 700 identifies a first pruning mask corresponding to the first inference task type, and identifying a second pruning mask corresponding to the second inference task. The first pruning mask identifies the first subset of model weights or parameters of the inference model. The second pruning mask identifies the second subset of model weights or parameters of the inference model. In at least one embodiment, the first pruning mask is one of the following: a mask for a first programming language, a mask for a second programming language, a mask for a language translation, or a mask for logical reasoning and mathematical analysis. The second pruning mask is different one of the following: the mask for the first programming language, the mask for the second programming language, the mask for the language translation, or the mask for the logical reasoning and mathematical analysis.

In a further embodiment, the one or more processing units executing method 700 receives from the first inference node, a request for one or more additional model weights or parameters of the inference model. The one or more processing units executing method 700 fetches, from the one or remote nodes over the network, the one or more additional model weights or parameters, and loads the one or more additional model weights or parameters into the local memory of the first inference node. The one or more processing units executing method 700 loads the first subset of model weights or parameters into the local memory by performing zero-copy operations to directly load the first subset of model weights or parameters into the local memory.

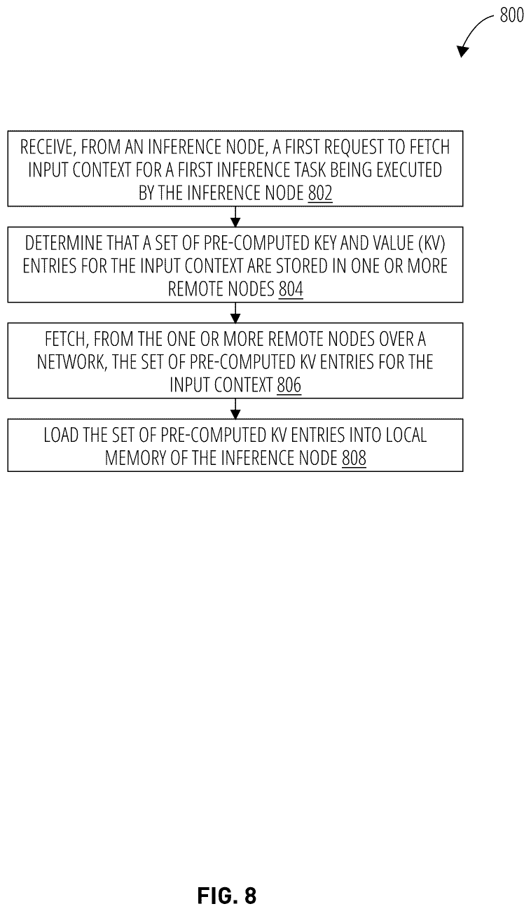

FIG. 8 is a flow diagram of a method 800 for managing a distributed memory hierarchy according to at least one embodiment. The method 800 can be performed using one or more processing units (e.g., CPUs, GPUs, accelerators, physics processing units (PPUs), data processing units (DPUs), etc.), which may include (or communicate with) one or more memory devices. In at least one embodiment, the method 700 can be performed using a processing device or processing devices. In at least one embodiment, the method 700 can be performed using one or more processing units of a component of FIG. 1A. In at least one embodiment, the method 800 can be performed using one or more processing units of a component of FIG. 2 or FIG. 3. In at least one embodiment, the method 800 can be performed using one or more processing units of a component of FIG. 5. In at least one embodiment, processing units performing the method 800 can be executing instructions stored on a non-transient computer readable storage media. In at least one embodiment, the method 800 can be performed using multiple processing threads (e.g., CPU threads and/or GPU threads), individual threads executing one or more individual functions, routines, subroutines, or operations of the method. In at least one embodiment, processing threads implementing the method 800 can be synchronized (e.g., using semaphores, critical sections, and/or other thread synchronization mechanisms). Alternatively, processing threads implementing the method 800 can be executed asynchronously with respect to each other. Various operations of the method 800 can be performed in a different order compared with the order shown in FIG. 8. Some operations of the method 800 can be performed concurrently with other operations. In at least one embodiment, one or more operations shown in FIG. 8 may not always be performed.

At block 802, the one or more processing units executing method 800 receives, from an inference node, a first request to fetch input context for a first inference task being executed by the inference node. At block 804, the one or more processing units executing method 800 determines that a set of pre-computed key and value (KV) entries for the input context are stored in one or more remote nodes. At block 806, the one or more processing units executing method 800 fetches, from the one or more remote nodes over a network, the set of pre-computed KV entries for the input context. At block 808, the one or more processing units executing method 800 loads the set of pre-computed KV entries into local memory of the inference node.

In a further embodiment, the set of pre-computed KV entries is computed in a prefill phase of a scaled dot-product attention operation by the inference node using a set of input tokens associated with the first inference task. The one or more processing units executing method 800 receives the first request as part of a subsequent phase to the prefill phase. The subsequent phase is a decode phase or autoregressive generation phase that uses set of pre-computed KV entries to generate a new token for the set of input tokens.

In at least one embodiment, the one or more processing units executing method 800 receiving the first request as part of a prefill phase of a scaled dot-product attention operation by the inference node. In at least one embodiment, the one or more processing units executing method 800 receiving the first request as part of a retrieval step of a Retrieval-Augmented Generation (Retrieval-Augmented Generation (RAG)) pipeline executed by the inference node. The set of pre-computed KV entries is associated with a portion of the input context provided by a vector database.

In at least one embodiment, the one or more processing units executing method 800 receives configuration data identifying a plurality of memory nodes, each memory node located at the inference node or at one or more remote nodes. The one or more processing units executing method 800 determines, using the configuration data, a distributed memory hierarchy that organizes the plurality of memory nodes into a plurality of memory levels for the inference node. The one or more processing units executing method 800 configures each of the plurality of memory nodes according to the distributed memory hierarchy. The one or more processing units executing method 800 receives one or more requests from the inference node over the host interface. The one or more processing units executing method 800 interacts with one or more of the plurality of memory nodes to perform memory operations for the inference node.

In at least one embodiment, the one or more processing units executing method 800 loads, for the first inference task, a set of model weights or parameters into first-level memory of the plurality of memory levels of the distributed memory hierarchy. The one or more processing units executing method 800 loads, for the first inference task, the set of pre-computed KV entries into at least one of the first-level memory or second-level memory of the plurality of memory levels of the distributed memory hierarchy.

In at least one embodiment, the one or more processing units executing method 800 prefetches the set of model weights or parameters and the set of pre-computed KV entries from one or more memory nodes located at one or more remote nodes into local memory nodes located at the inference node based on a scheduled inference workload. The one or more processing units executing method 800 evicts unused model weights or parameters from the local memory nodes according to the scheduled inference workload.

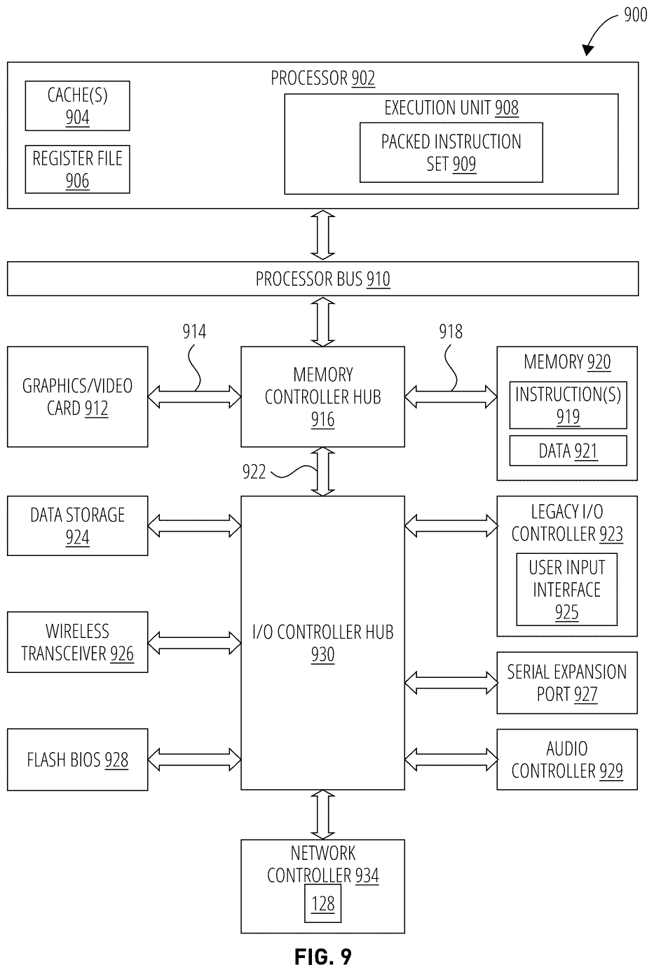

FIG. 9 is a block diagram illustrating an exemplary computer system 900, which may be a system with interconnected devices and components, a system-on-a-chip (SOC) or some combination thereof formed with a processor that may include execution units to execute an instruction, according to at least one embodiment. In at least one embodiment, computer system 900 may include, without limitation, a component, such as a processor 902 to employ execution units including logic to perform algorithms for process data, in accordance with present disclosure, such as in embodiment described herein. In at least one embodiment, computer system 900 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 900 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 900 may include, without limitation, processor 902 that may include, without limitation, one or more execution units 908 to perform machine learning model training and/or inferencing according to techniques described herein. In at least one embodiment, computer system 900 is a single processor desktop or server system, but in another embodiment, computer system 900 may be a multiprocessor system. In at least one embodiment, processor 902 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 902 may be coupled to a processor bus 910 that may transmit data signals between processor 902 and other components in computer system 900.

In at least one embodiment, processor 902 may include, without limitation, a Level 1 (“L1”) internal cache memory (“cache”) 904. In at least one embodiment, processor 902 may have a single internal cache or multiple levels of internal cache. In at least one embodiment, cache memory may reside external to processor 902. Other embodiments may also include a combination of both internal and external caches depending on particular implementation and needs.

In at least one embodiment, processor 902 may include, without limitation, a Level 2 (“L2”) internal cache memory (“cache”) 904. The L2 cache can serve as a secondary, larger, and somewhat slower cache compared to the L1 cache that is still faster than accessing the main memory (e.g., via the memory controller hub 916). Thus, the L2 cache can enhance performance by reducing the time the processor spends accessing the main memory. In at least one embodiment, processor 902 may have a single internal L2 cache or multiple levels of internal cache. In embodiments where the processor 902 is a multi-core processor, the L2 cache can be shared among multiple cores of processor 902, providing a larger, intermediate level of cache memory for more than one processing core. In at least one embodiment, L2 cache memory may reside external to processor 902.

In at least one embodiment, processor 902 may include, without limitation, a Level 3 (“L3”) internal cache memory (“cache”) 904. The L3 cache can serve as a tertiary, larger, and slower cache compared to both the L1 and L2 caches. The L3 cache can enhance performance by reducing the time the processor spends accessing the main memory. The L3 cache can be shared among multiple cores of processor 902, providing a larger pool of fast-access memory for data for the processor cores. In at least one embodiment, processor 902 may have a single internal L3 cache or multiple levels of internal cache. In at least one embodiment, L3 cache memory may reside external to processor 902. Other embodiments may also include any combination of internal or external L1, L2, and/or L3 caches depending on particular implementation and needs. In at least one embodiment, register file 906 may store different types of data in various registers including, without limitation, integer registers, floating point registers, status registers, and instruction pointer register.

In at least one embodiment, execution unit 908, including, without limitation, logic to perform integer and floating point operations, also resides in processor 902. In at least one embodiment, processor 902 may also include a microcode (“ucode”) read only memory (“ROM”) that stores microcode for certain macro instructions. In at least one embodiment, execution unit 908 may include logic to handle a packed instruction set 909. In at least one embodiment, by including packed instruction set 909 in an instruction set of a general-purpose processor 902, along with associated circuitry to execute instructions, operations used by many multimedia applications may be performed using packed data in a general-purpose processor 902. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 908 may also be used in microcontrollers, embedded processors, graphics devices, DSPs, and other types of logic circuits. In at least one embodiment, computer system 900 may include, without limitation, a memory 920. In at least one embodiment, memory 920 may be implemented as a Dynamic Random Access Memory (“DRAM”) device, a Static Random Access Memory (“SRAM”) device, flash memory device, or other memory device. In at least one embodiment, memory 920 may store instruction(s) 919 and/or data 921 represented by data signals that may be executed by processor 902.

In at least one embodiment, system logic chip may be coupled to processor bus 910 and memory 920. In at least one embodiment, system logic chip may include, without limitation, a memory controller hub (“MCH”) 916, and processor 902 may communicate with MCH 916 via processor bus 910. In at least one embodiment, MCH 916 may provide a high bandwidth memory path 918 to memory 920 for instruction and data storage and for storage of graphics commands, data and textures. In at least one embodiment, MCH 916 may direct data signals between processor 902, memory 920, and other components in computer system 900 and to bridge data signals between processor bus 910, memory 920, and a system I/O 922. In at least one embodiment, system logic chip may provide a graphics port for coupling to a graphics controller. In at least one embodiment, MCH 916 may be coupled to memory 920 through a high bandwidth memory path 918 and graphics/video card 912 may be coupled to MCH 916 through an Accelerated Graphics Port (“AGP”) interconnect 914.

In at least one embodiment, computer system 900 may use system I/O 922 that is a proprietary hub interface bus to couple MCH 916 to I/O controller hub (“ICH”) 930. In at least one embodiment, ICH 930 may provide direct connections to some I/O devices via a local I/O bus. In at least one embodiment, local I/O bus may include, without limitation, a high-speed I/O bus for connecting peripherals to memory 920, chipset, and processor 902. Examples may include, without limitation, an audio controller 929, a firmware hub (“flash BIOS”) 928, a wireless transceiver 926, a data storage 924, a legacy I/O controller 923 containing user input and keyboard interfaces 925, a serial expansion port 927, such as Universal Serial Bus (“USB”), and a network controller 934, which includes the distributed memory logic 128. In some embodiments, the network controller 934 is a NIC, a DPU, or the like. Data storage 924 may comprise a hard disk drive, a floppy disk drive, a CD-ROM device, a flash memory device, or other mass storage device.

In at least one embodiment, FIG. 9 illustrates a system, which includes interconnected hardware devices or “chips”, whereas in other embodiments, FIG. 9 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 900 are interconnected using compute express link (CXL) interconnects.

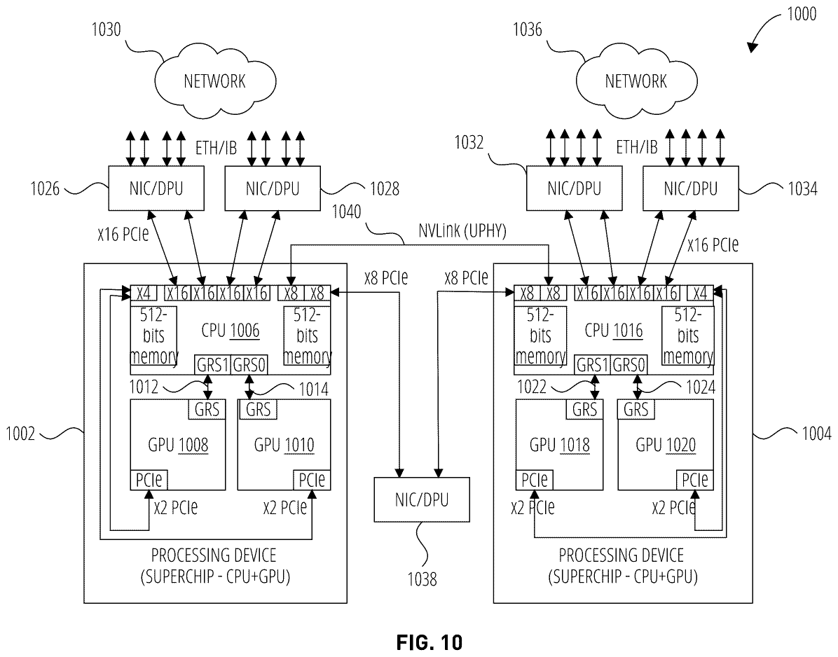

FIG. 10 is a block diagram of a computing system 1000 having two processing devices coupled to each other and multiple networks according to at least one embodiment. The computing system 1000 is designed with multiple integrated circuits (referred to as processing devices), where each integrated circuit includes a CPU and two GPUs, forming a powerful and flexible architecture. These processing devices are interconnected via an NVLink (or other high-speed interconnect), enabling high-speed communication between the processing devices, and are also connected through a Network Interface Card (NIC) or Data Processing Unit (DPU) to ensure efficient data transfer across the computing system 1000. The coupling of processing devices through NVLink allows for seamless data exchange and parallel processing, enhancing overall computational performance. Additionally, these processing devices are connected to multiple networks through one or more network interface cards (NICs) or DPUs, enabling the system to handle complex, multi-network tasks with high bandwidth and low latency. This configuration makes the computing system 1000 highly suitable for demanding applications that require significant processing power, such as artificial intelligence (AI), machine learning (ML), and data-intensive computing, while ensuring robust connectivity and scalability across various networked environments. The integrated circuits of the computing system 1000 can include one or more CPUs and one or more GPUs. An example architecture of a multi-GPU architecture is illustrated in FIG. 10.

As illustrated in FIG. 10, the computing system 1000 includes a processing device 1002 with a multi-GPU architecture. In particular, the processing device 1002 includes a CPU 1006, a GPU 1008, and a GPU 1010. The CPU 1006 can be coupled to the GPU 1008 via an die-to-die (D2D) or chip-to-chip (C2C) interconnect 1012, such as a Ground-Referenced Signaling interconnect (GRS interconnect). The CPU 1006 can be coupled to the GPU 1010 via a D2D or C2C interconnect 1014. The CPU 1006 can also couple to the GPU 1008 and GPU 1010 via PCIe interconnects. The CPU 1006 can be coupled to one or more network interface cards (NICs) or data processing units (DPUs), which are coupled to one or more networks. For example, as illustrated in FIG. 10, the CPU 1006 is coupled to a first NIC/DPU 1026, which is coupled to a network 1030. The CPU 1006 is also coupled to a second NIC/DPU 1028, which is coupled to the network 1030. The NIC/DPU 1026 and NIC/DPU 1028 can be coupled to the network 1030 over Ethernet (ETH) or InfiniBand (IB) connections.

The computing system 1000 also includes a processing device 1004 with a multi-GPU architecture. In particular, the processing device 1004 includes a CPU 1016, a GPU 1018, and a GPU 1020. The CPU 1016 can be coupled to the GPU 1018 via an D2D or C2C interconnect 1022. The CPU 1016 can be coupled to the GPU 1020 via a D2D or C2C interconnect 1024. The CPU 1016 can also couple to the GPU 1018 and GPU 1020 via PCIe interconnects. The CPU 1016 can be coupled to one or more NICs or DPUs, which are coupled to one or more networks. For example, as illustrated in FIG. 10, the CPU 1016 is coupled to a first NIC/DPU 1032, which is coupled to a network 1036. The CPU 1016 is also coupled to a second NIC/DPU 1034, which is coupled to the network 1036. The NIC/DPU 1032 and NIC/DPU 1034 can be coupled to the network 1036 over Ethernet (ETH) or InfiniBand (IB) connections.

In at least one embodiment, the processing device 1002 and the processing device 1004 can communication with each other via a NIC/DPU 1038, such as over PCIe interconnects. The processing device 1002 and processing device 1004 can also communicate with each other over a high-bandwidth communication interconnects 1040, such as an NVLink interconnect or other high-speed interconnects. The NIC/DPUs of FIG. 10 can be the various embodiments of the DPUs described herein. The NIC/DPUs of FIG. 10 can include the distributed memory logic 128 as described herein.

In at least one embodiment, the computing system 1000 is used for high-speed network communication and includes a processing unit (e.g., CPU 1006, GPU 1008, GPU 1010, CPU 1016, GPU 1018, GPU 1020, NIC/DPU 1026, NIC/DPU 1028, NIC/DPU 1032, NIC/DPU 1034, or NIC/DPU 1038), and a network interface operatively coupled to the processing unit. The network interface can include the operations and functionality of the DPUs described herein.

In at least one embodiment, the computing system 1000 includes a host device and an auxiliary device. The auxiliary device includes a device memory and a processor, communicably coupled to the device memory. The auxiliary device performs the operations described herein with respect to FIG. 1A to FIG. 9. The auxiliary device can include a GPU. The auxiliary device can include a DPU. The auxiliary device can include a DPU. The auxiliary device can include accelerator hardware.

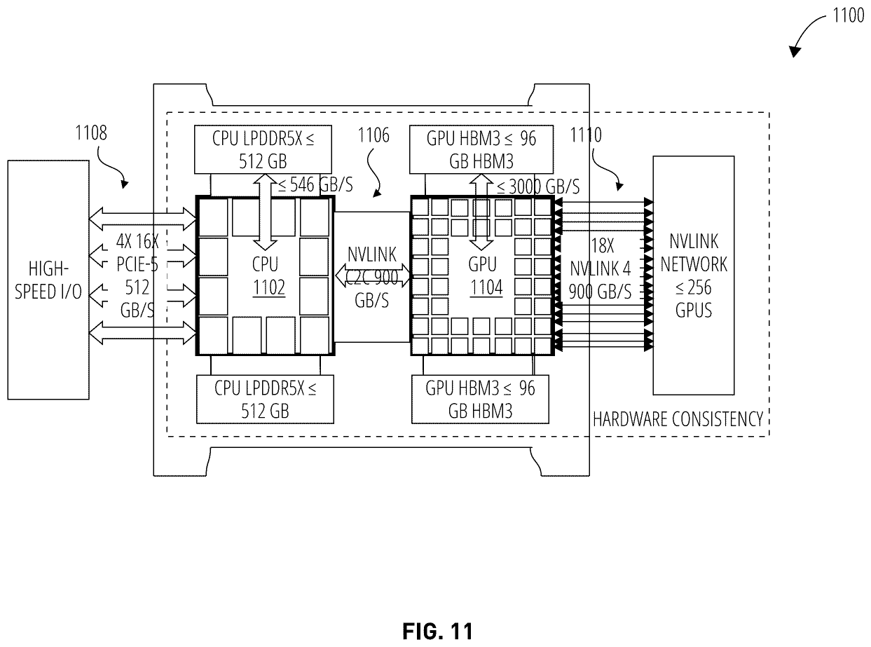

FIG. 11 is a block diagram of a computing system 1100 having a CPU 1102 and a GPU 1104 in a single integrated circuit according to at least one embodiment. The computing system 1100 can be a highly integrated design where a CPU 1102 and GPU 1104 are connected on a single integrated circuit, utilizing an NVLink C2C (Chip-to-Chip) interconnect 1106 to enable fast, low-latency communication between the two processing units. This close integration allows for efficient data transfer and parallel processing between the CPU 1102 and GPU 1104, optimizing performance for complex computational tasks. The GPU elements within the computing system 1100 can be interconnected using an NVLink network, allowing for scalability up to 256 GPU elements, creating a powerful, unified processing environment ideal for large-scale AI, ML, and high-performance computing applications. The NVLink network can be a GPU fabric of high-bandwidth communication interconnects 1110. Additionally, the computing system 1100 can be designed to interface with a high-speed I/O through PCIe interconnects 1108, ensuring rapid data transfer to and from external devices, further enhancing the system's capabilities in handling data-intensive tasks and providing robust connectivity to peripheral components. It should be noted that the C2C interconnects 1106 can be considered D2D interconnects since the CPU 1102 and the GPU 1104 are located on the same integrated circuit. The integrated circuit can include CPU memory (also referred to as main memory) and GPU memory, which are accessible by the CPU 1102 and the GPU 1104, respectively, over high-speed interconnects. The computing system 1100 can bring together performance of the GPU 1104 with the versatility of the CPU 1102. The CPU 1102 can be connected with a high-bandwidth and memory coherent C2C interconnects 1106 in a single integrated circuit. The computing system 1100 can support a link switch system.

The computing system 1100 can include the distributed memory logic 128 used for the various embodiments described herein with respect to FIG. 1A to FIG. 9.

In at least one embodiment, the computing system 1100 is used for high-speed network communication and includes a processing unit, and a network interface operatively coupled to the processing unit. The network interface can include the operations and functionality of the DPUs described herein.

In at least one embodiment, the computing system 1100 includes a host device and an auxiliary device. The auxiliary device includes a device memory and a processor, communicably coupled to the device memory. The auxiliary device performs the operations described herein with respect to FIG. 1A to FIG. 9. The auxiliary device can include a GPU. The auxiliary device can include a DPU. The auxiliary device can include a DPU. The auxiliary device can include accelerator hardware.

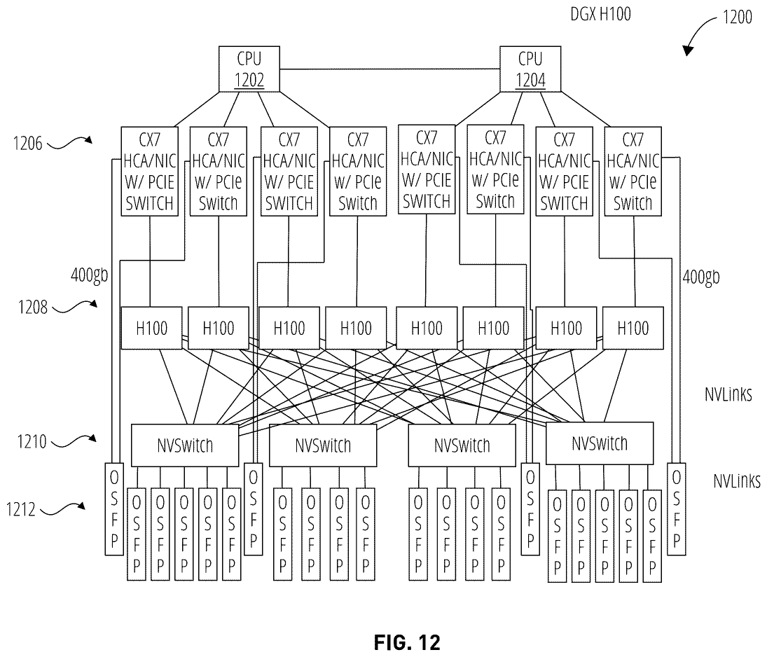

FIG. 12 is a block diagram of a computing system 1200 having tensor core GPUs 1208 according to at least one embodiment. The computing system 1200 can be a DGX H100 system, which is a high-performance computing platform designed to meet the demands of AI, ML, and deep learning (DL) workloads. The computing system 1200 can include multiple tensor core GPUs 1208 (e.g., NVIDIA H100 Tensor Core GPUs). The tensor core GPUs 1208 can each be one of the integrated circuits described above with respect to FIG. 11. The tensor core GPUs 1208 can be optimized for AI/ML/DL applications, offering exceptional performance for deep learning training, inference, and high-performance computing tasks. The tensor core GPUs 1208 within the computing system 1200 are interconnected using high-speed communication interfaces like NVLinks, enabling rapid data transfer between them, which is crucial for handling large-scale AI models and datasets with low latency. This computing system 1200 is designed for scalability, allowing for the integration of additional GPUs as required, making it versatile enough for research, development, and deployment in data centers for production AI workloads. Each GPU is equipped with Tensor Cores, specialized processing units that accelerate matrix operations, a fundamental component of AI and deep learning algorithms. These Tensor Cores enable the system to perform mixed-precision calculations efficiently, balancing speed and accuracy. Given the power consumption and heat generation of multiple tensor core GPUs 1208, the computing system 1200 can include advanced cooling solutions and power management features to ensure safe operation while maintaining peak performance. It is supported by a comprehensive software ecosystem, including NVIDIA's CUDA programming model, AI frameworks like TensorFlow and PyTorch, and other HPC and AI software tools, which enable developers and researchers to harness the full power of the tensor core GPUs 1208 for their specific applications. The computing system 1200 is ideally suited for large-scale AI model training, real-time inference, scientific simulations, data analytics, and other compute-intensive tasks that require massive parallel processing power.

The tensor core GPUs 1208 can be coupled to multiple CPUs, such as CPU 1202 and CPU 1204, using switches 1206 (e.g., CX7 HCA/NIC with PCIe switch). The tensor core GPUs 1208 can be coupled to each other via switches 1210 (e.g., NVSwitches). The switches 1206 and switches 1210 can be coupled to high-speed transceiver modules 1212. The high-speed transceiver modules 1212 can be Octal Small Form-factor Pluggable (OSFP) modules. OSFP modules refer to high-speed transceiver modules designed for rapid data communication, particularly in environments requiring significant bandwidth, such as data centers and high-performance computing systems. These modules support extremely high data rates, typically up to 400 Gbps per module, with future capabilities extending to 800 Gbps or more. OSFP modules interface with the system via the PCIe interface, enabling fast and efficient data transfer between the integrated CPU-GPU components and external networks or other connected systems. Their hot-pluggable nature allows for easy insertion or removal without the need to power down the system, offering flexibility and ease of maintenance, which is crucial in critical-uptime environments. Additionally, OSFP modules are designed for high density, maximizing the number of high-speed connections within limited space, such as in densely packed server racks. By adhering to the latest networking standards, OSFP modules ensure the computing system 1200 remains capable of meeting increasing data demands and can be upgraded to support future advancements in network speeds, thus contributing to the system's overall performance and scalability.

In at least one embodiment, the computing system 1200 can be considered a data-network configuration with full-bandwidth intra-server NVLinks. In this example, all eight tensor core GPUs 1208 can simultaneously saturate eighteen NVLinks to other GPUs within the server. The bandwidth is limited by over-subscription from multiple other GPUs. In another embodiments, data-network configuration can be a half-bandwidth intra-server NVLinks. In this example, all eight tensor core GPUs 1208 can half-subscribe eighteen NVLinks to GPUs in other servers. Four tensor core GPUs 1208 can saturate eighteen NVLinks to GPUs in other servers. This is equivalent of full-bandwidth on AllReduce with Scalable Hierarchical Aggregation and Reduction Protocol (SHARP). The reduction in all-2-all (All2All) bandwidth is a balance with server complexity and costs. In at least one embodiment, all eight tensor core GPUs 1208 can independently transfer data, using Remote Direct Memory Access (RDMA) protocol, over its own dedicated switch (e.g., 400 Gb/s HCA/NIC) in an multi-rail InfiniBand/Ethernet configuration. In this example, 800 GBps of aggregate full-duplex to non-NVLink network devices.

The NICs/switches of computing system 1200 can include the various embodiments of the distributed memory logic 128 as described herein with respect to FIG. 1A to FIG. 9.

In at least one embodiment, the computing system 1200 is used for high-speed network communication and includes a processing unit (e.g., CPU 1202, CPU 1204, switches 1206, tensor core GPUs 1208, switches 1210, high-speed transceiver modules 1212), and a network interface operatively coupled to the processing unit. The network interface can include a receiver or a transceiver and perform the corresponding operations and functionalities described herein. The processing unit can include a CPU, a GPU, a DPU, a network adapter, a network switch, an NVLink switch, or the like.

In at least one embodiment, the computing system 1200 includes a host device and an auxiliary device. The auxiliary device includes a device memory and a processor, communicably coupled to the device memory. The auxiliary device performs the operations described herein with respect to FIG. 1A to FIG. 9. The auxiliary device can include a GPU. The auxiliary device can include a DPU. The auxiliary device can include a DPU. The auxiliary device can include accelerator hardware.

Other variations are within the spirit of the present disclosure. Thus, while disclosed techniques are susceptible to various modifications and alternative constructions, certain illustrated embodiments thereof are shown in drawings and have been described above in detail. It should be understood, however, that there is no intention to limit the disclosure to a specific form or forms disclosed, but on the contrary, the intention is to cover all modifications, alternative constructions, and equivalents falling within the spirit and scope of the disclosure, as defined in appended claims.

Use of terms “a” and “an” and “the” and similar referents in the context of describing disclosed embodiments (especially in the context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. The term “connected,” when unmodified and referring to physical connections, is to be construed as partly or wholly contained within, attached to, or joined together, even if there is something intervening. Recitations of ranges of values herein are merely intended to serve as a shorthand method of referring individually to each separate value falling within range unless otherwise indicated herein, and each separate value is incorporated into the specification as if it were individually recited herein. Use of the term “set” (e.g., “a set of items”) or “subset,” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of the form “at least one of A, B, and C,” or “at least one of A, B, and C,” unless specifically stated otherwise or otherwise clearly contradicted by context, is otherwise understood with the context as used in general to present that an item, term, etc., may be either A or B or C, or any nonempty subset of a set of A and B and C. For instance, in the illustrative example of a set having three members, conjunctive phrases “at least one of A, B, and C” and “at least one of A, B, and C” refers to any of the following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, the term “plurality” indicates a state of being plural (e.g., “a plurality of items” indicates multiple items). A plurality is at least two items but can be more when so indicated either explicitly or by context. Further, unless stated otherwise or otherwise clear from context, the phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause a computer system to perform operations described herein. A set of non-transitory computer-readable storage media, in at least one embodiment, comprises multiple non-transitory computer-readable storage media, and one or more individual non-transitory storage media of multiple non-transitory computer-readable storage media lack all of the code while multiple non-transitory computer-readable storage media collectively store all of the code. In at least one embodiment, executable instructions are executed such that different instructions are executed by different processors-for example, a non-transitory computer-readable storage medium stores instructions, and a main CPU executes some of the instructions while a GPU executes other instructions. In at least one embodiment, different components of a computer system have separate processors, and different processors execute different subsets of instructions.

Accordingly, in at least one embodiment, computer systems are configured to implement one or more services that singly or collectively perform operations of processes described herein, and such computer systems are configured with applicable hardware and/or software that enable the performance of operations. Further, a computer system that implements at least one embodiment of present disclosure is a single device and, in another embodiment, is a distributed computer system comprising multiple devices that operate differently such that the distributed computer system performs operations described herein and such that a single device does not perform all operations.

Use of any and all examples, or exemplary language (e.g., “such as”) provided herein, is intended merely to better illuminate embodiments of the disclosure, and does not pose a limitation on the scope of the disclosure unless otherwise claimed. No language in the specification should be construed as indicating any non-claimed element as essential to the practice of the disclosure.

All references, including publications, patent applications, and patents, cited herein are hereby incorporated by reference to the same extent as if each reference were individually and specifically indicated to be incorporated by reference and were set forth in its entirety herein.

The terms “coupled” and “connected,” along with their derivatives, may be used in the description and claims. It should be understood that these terms may not be intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other but yet still CO-operate or interact with each other.

Unless specifically stated otherwise, it may be appreciated that throughout specification terms such as “processing,” “computing,” “calculating,” “determining,” or like, refer to action and/or processes of a computer or computing system or similar electronic computing devices, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, a “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes for carrying out instructions in sequence or parallel, continuously, or intermittently. The terms “system” and “method” are used herein interchangeably as far as a system may embody one or more methods, and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways, such as by receiving data as a parameter of a function call or a call to an application programming interface. In some implementations, the process of obtaining, acquiring, receiving, or inputting analog or digital data can be accomplished by transferring data via a serial or parallel interface. In another implementation, the process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, the process of providing, outputting, transmitting, sending, or presenting analog or digital data can be accomplished by transferring data as an input or output parameter of a function call, a parameter of an application programming interface, or inter-process communication mechanism.

Although the discussion above sets forth example implementations of described techniques, other architectures may be used to implement the described functionality and are intended to be within the scope of this disclosure. Furthermore, although specific distributions of responsibilities are defined above for purposes of discussion, various functions and responsibilities might be distributed and divided in different ways, depending on circumstances.

Furthermore, although the subject matter has been described in language specific to structural features and/or methodological acts, it is to be understood that the subject matter claimed in appended claims is not necessarily limited to specific features or acts described. Rather, specific features and acts are disclosed as exemplary forms of implementing the claims.

What is claimed is:

1. A programmable network device comprising:
a processing unit;
memory operatively coupled to the processing unit;
a host interface operatively coupled to the processing unit and an inference node; and
a network interface operatively coupled to the processing unit and one or more remote nodes over a network, wherein the memory is to store instructions that, when executed by the processing unit, cause the programmable network device to:
receive, from the inference node, a first request to fetch input context for a first inference task being executed by the inference node;
determine that a set of pre-computed key and value (KV) entries for the input context are stored in the one or more remote nodes;
fetch, from the one or more remote nodes over the network, the set of pre-computed KV entries for the input context; and
load the set of pre-computed KV entries into local memory of the inference node.

2. The programmable network device of claim 1, wherein the set of pre-computed KV entries is computed in a prefill phase of a scaled dot-product attention operation by the inference node using a set of input tokens associated with the first inference task, and wherein the programmable network device is to receive the first request as part of a subsequent phase to the prefill phase, wherein the subsequent phase is a decode phase or autoregressive generation phase that uses set of pre-computed KV entries to generate a new token for the set of input tokens.

3. The programmable network device of claim 1, wherein the programmable network device is to receive the first request as part of a prefill phase of a scaled dot-product attention operation by the inference node.

4. The programmable network device of claim 1, wherein the programmable network device is to receive the first request as part of a retrieval step of a Retrieval-Augmented Generation (RAG) pipeline executed by the inference node, wherein the set of pre-computed KV entries is associated with a portion of the input context provided by a vector database.

5. The programmable network device of claim 1, wherein the one or more remote nodes comprises a remote memory mode to store model weights or parameters of an inference model and the set of pre-computed KV entries.

6. The programmable network device of claim 1, wherein the programmable network device is further to:
receive configuration data identifying a plurality of memory nodes, each memory node located at the inference node or at one or more remote nodes;
determine, using the configuration data, a distributed memory hierarchy that organizes the plurality of memory nodes into a plurality of memory levels for the inference node;
configure each of the plurality of memory nodes according to the distributed memory hierarchy;
receive one or more requests from the inference node over the host interface; and
interact with one or more of the plurality of memory nodes to perform memory operations for the inference node.

7. The programmable network device of claim 6, wherein the programmable network device is further to:
load, for the first inference task, a set of model weights or parameters into first-level memory of the plurality of memory levels of the distributed memory hierarchy; and
load, for the first inference task, the set of pre-computed KV entries into at least one of the first-level memory or second-level memory of the plurality of memory levels of the distributed memory hierarchy.

8. The programmable network device of claim 7, wherein the programmable network device is further to:
prefetch the set of model weights or parameters and the set of pre-computed KV entries from one or more memory nodes located at one or more remote nodes into local memory nodes located at the inference node based on a scheduled inference workload; and
evict unused model weights or parameters from the local memory nodes according to the scheduled inference workload.

9. A programmable network device comprising distributed memory logic to:
receive, from an inference node, a first request to fetch input context for a first inference task being executed by the inference node;
determine that a set of pre-computed key and value (KV) entries for the input context are stored in one or more remote nodes;
fetch, from the one or more remote nodes over a network, the set of pre-computed KV entries for the input context; and
load the set of pre-computed KV entries into local memory of the inference node.

10. The programmable network device of claim 9, wherein the set of pre-computed KV entries is computed in a prefill phase of a scaled dot-product attention operation by the inference node using a set of input tokens associated with the first inference task, and wherein the distributed memory logic is to receive the first request as part of a subsequent phase to the prefill phase, wherein the subsequent phase is a decode phase or autoregressive generation phase that uses set of pre-computed KV entries to generate a new token for the set of input tokens.

11. The programmable network device of claim 9, wherein the distributed memory logic is to receive the first request as part of a prefill phase of a scaled dot-product attention operation by the inference node.

12. The programmable network device of claim 9, wherein the distributed memory logic is to receive the first request as part of a retrieval step of a Retrieval-Augmented Generation (RAG) pipeline executed by the inference node, wherein the set of pre-computed KV entries is associated with a portion of the input context provided by a vector database.

13. The programmable network device of claim 9, wherein the one or more remote nodes comprises a remote memory mode to store model weights or parameters of an inference model and the set of pre-computed KV entries.

14. The programmable network device of claim 9, wherein the distributed memory logic is further to:
receive configuration data identifying a plurality of memory nodes, each memory node located at the inference node or at one or more remote nodes;
determine, using the configuration data, a distributed memory hierarchy that organizes the plurality of memory nodes into a plurality of memory levels for the inference node;
configure each of the plurality of memory nodes according to the distributed memory hierarchy;
receive one or more requests from the inference node over the host interface; and
interact with one or more of the plurality of memory nodes to perform memory operations for the inference node.

15. The programmable network device of claim 14, wherein the distributed memory logic is further to:
load, for the first inference task, a set of model weights or parameters into first-level memory of the plurality of memory levels of the distributed memory hierarchy; and
load, for the first inference task, the set of pre-computed KV entries into at least one of the first-level memory or second-level memory of the plurality of memory levels of the distributed memory hierarchy.

16. The programmable network device of claim 15, wherein the distributed memory logic is further to:
prefetch the set of model weights or parameters and the set of pre-computed KV entries from one or more memory nodes located at one or more remote nodes into local memory nodes located at the inference node based on a scheduled inference workload; and
evict unused model weights or parameters from the local memory nodes according to the scheduled inference workload.

17. A method comprising:
receiving, from an inference node, a first request to fetch input context for a first inference task being executed by the inference node;
determining that a set of pre-computed key and value (KV) entries for the input context are stored in one or more remote nodes;
fetching, from the one or more remote nodes over a network, the set of pre-computed KV entries for the input context; and
loading the set of pre-computed KV entries into local memory of the inference node.

18. The method of claim 17, wherein the set of pre-computed KV entries is computed in a prefill phase of a scaled dot-product attention operation by the inference node using a set of input tokens associated with the first inference task, and wherein receiving the first request comprises receiving the first request as part of a subsequent phase to the prefill phase,
wherein the subsequent phase is a decode phase or autoregressive generation phase that uses set of pre-computed KV entries to generate a new token for the set of input tokens.

19. The method of claim 17, wherein receiving the first request comprises receiving the first request as part of a prefill phase of a scaled dot-product attention operation by the inference node.

20. The method of claim 17, wherein receiving the first request comprises receiving the first request as part of a retrieval step of a Retrieval-Augmented Generation (RAG) pipeline executed by the inference node, wherein the set of pre-computed KV entries is associated with a portion of the input context provided by a vector database.
